(19) United States
(12) Patent Application Publication
(10) Pub. No.: US 2026/0278673 A1
(43) Pub. Date: Sep. 17, 2026

(54) SYSTEM

(71) Applicant: SoftBank Group Corp., Tokyo (JP)

(72) Inventor: Manabu ONO, Tokyo (JP)

(73) Assignee: SoftBank Group Corp., Tokyo (JP)

(21) Appl. No.: 19/550,368

(22) Filed: Feb. 26, 2026

Related U.S. Application Data
(60) Provisional application No. 63/770,824, filed on Mar. 12, 2025.

(51) Int. Cl. G06Q 40/02; G06F 18/22; G06F 40/30; G06N 3/045

(52) U.S. Cl. CPC G06Q 40/024; G06F 18/22; G06F 40/30; G06N 3/045

(57) ABSTRACT

A system includes a processor that is configured to obtain input information from a remitter, and analyze a purpose of a transfer and information of a transfer destination by performing natural language processing on the input information, compare information of the remitter, obtained by the processor, with a police special fraud information database and with a list of phone numbers used in crimes in real time, and determine a possibility of fraud based on a result of the comparison, and issue a warning to the remitter and temporarily restrict execution of the transfer when the possibility of fraud is determined.

### CROSS-REFERENCE TO RELATED APPLICATION

This application claims the benefit of U.S. Provisional Application No. 63/770,824, filed on Mar. 12, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional automated teller machine (ATM) transfer systems and remote banking systems generally rely on static rule-based checks and simple transaction limits to prevent fraudulent transfers. Such systems are often unable to adequately detect and prevent so-called special fraud, including impersonation fraud, emergency remittance fraud, and other sophisticated scams in which a fraudster induces a remitter to initiate a transfer under false pretenses. In particular, conventional systems do not sufficiently analyze the semantic content of the remitter's explanations regarding a purpose of a transfer and a relationship to a transfer destination, do not sufficiently correlate such explanations with external fraud information sources in real time, and do not dynamically interact with the remitter to interrupt or delay a suspicious transaction. As a result, there is a risk that a remitter, especially an elderly or vulnerable person, may complete a fraudulent transfer despite generic on-screen warnings or simple confirmation prompts. Therefore, there is a need for a system that can intelligently analyze natural language input from a remitter, perform real-time matching with fraud-related databases, and actively control the transfer process by issuing context-aware warnings, temporarily restricting execution of a transfer, and guiding the remitter through additional verification steps, thereby reducing the likelihood of successful fraudulent transfers.

### SUMMARY

In order to solve the above-described problems, an embodiment of the invention provides a system comprising a processor, wherein the processor is configured to obtain input information from a remitter and analyze a purpose of a transfer and information of a transfer destination by performing natural language processing on the input information. The processor is further configured to compare information of the remitter, obtained by the processor, with a police special fraud information database and with a list of phone numbers used in crimes in real time, and to determine a possibility of fraud based on a result of the comparison. In response to determining the possibility of fraud, the processor is configured to issue a warning to the remitter and temporarily restrict execution of the transfer. In certain embodiments, the processor is also configured to present questions to the remitter by voice or on a display screen, collect detailed information regarding the purpose of the transfer and a relationship to the transfer destination based on answers to the questions, and more accurately recognize an intention of the remitter based on the detailed information. In still other embodiments, the processor is configured to present additional questions when the remitter attempts to ignore the warning, to provide a process in which the remitter is requested to prove that there is no possibility of fraud, and to provide an opportunity for the remitter to calmly re-evaluate a situation of the transfer. By combining natural language analysis, real-time database matching, and interactive control of the transfer flow, the system can effectively identify and interrupt potentially fraudulent transfers before completion.

The term “processor” refers to one or more hardware computing units, such as a central processing unit (CPU), a microcontroller, or a system-on-chip, and may further include associated memory and circuitry configured to execute programmed instructions to perform the functions described herein.

The term “remitter” refers to a person or entity that initiates a funds transfer, such as a bank customer using an automated teller machine, terminal, or remote banking interface to request execution of a transfer to a recipient.

The term “input information” refers to information provided by the remitter to the system, including but not limited to text input, voice input, selections made via a graphical user interface, and transaction parameters such as a transfer amount, a transfer purpose, and recipient information.

The term “natural language processing” refers to a class of computational techniques for analyzing, interpreting, and understanding human language expressed in text or speech, including but not limited to tokenization, parsing, semantic analysis, intent recognition, and generation of structured data from unstructured language.

The term “purpose of a transfer” refers to a reason, objective, or use case described by the remitter for executing a funds transfer, such as payment for goods or services, repayment of a loan, financial assistance to a family member, or any other stated motivation. The term “information of a transfer destination” refers to data identifying or describing a recipient of a transfer, including but not limited to a recipient name, account number, bank or branch identifier, phone number, and any additional attributes used to distinguish the recipient.

The term “police special fraud information database” refers to an external or internal database that stores information relating to special fraud cases, such as known fraudulent accounts, entities, schemes, patterns, and other fraud-related records provided or endorsed by law enforcement authorities.

The term “list of phone numbers used in crimes” refers to a data set containing phone numbers that have been identified, registered, or flagged as having been used, or being suspected of being used, in connection with criminal activities, including fraud.

The term “real time” refers to a processing mode in which the system performs analysis, matching, and decision making within a time period short enough to interactively influence an ongoing transfer transaction without perceptible or unacceptable delay to the remitter.

The term “possibility of fraud” refers to a likelihood, risk level, or probability, determined by the system based on analysis and comparison of data, that a given transfer transaction is being initiated or influenced by fraudulent activity or deception.

The term “warning” refers to a notification, message, or alert presented to the remitter, by display, audio output, or other interface, indicating that the transfer may be fraudulent or risky and advising the remitter to review, confirm, or reconsider the transaction.

The term “temporarily restrict execution of the transfer” refers to delaying, suspending, or preventing completion of a transfer transaction for at least a specified period or until additional checks or confirmations are performed, while not necessarily canceling the transaction permanently.

The term “questions” refers to inquiries presented to the remitter, by voice output or on a display screen, for the purpose of eliciting additional information, confirmations, or clarifications regarding the transfer purpose, the recipient, or the circumstances of the transfer.

The term “relationship to the transfer destination” refers to a type or nature of association between the remitter and the recipient, such as family member, friend, business partner, service provider, or other social or contractual connection.

The term “intention of the remitter” refers to the actual goal, understanding, or mental state of the remitter with respect to the transfer, as inferred by the system from the remitter's input information and answers, including whether the remitter is knowingly or unknowingly responding to fraudulent instructions.

The term “additional questions” refers to further inquiries presented to the remitter after an initial warning has been issued, used to gather more specific or detailed information to refine the assessment of fraud risk and to prompt the remitter to reconsider the transfer.

The term “prove that there is no possibility of fraud” refers to a process in which the remitter provides additional explanations, confirmations, or evidence, through answers to questions or other input, that support a conclusion by the system that the transfer is legitimate or that fraud risk is acceptably low.

The term “re-evaluate a situation of the transfer” refers to an action encouraged by the system in which the remitter is given time and guidance to reconsider the circumstances of the transfer, including verifying the recipient's identity or contacting a trusted party, before deciding whether to proceed.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

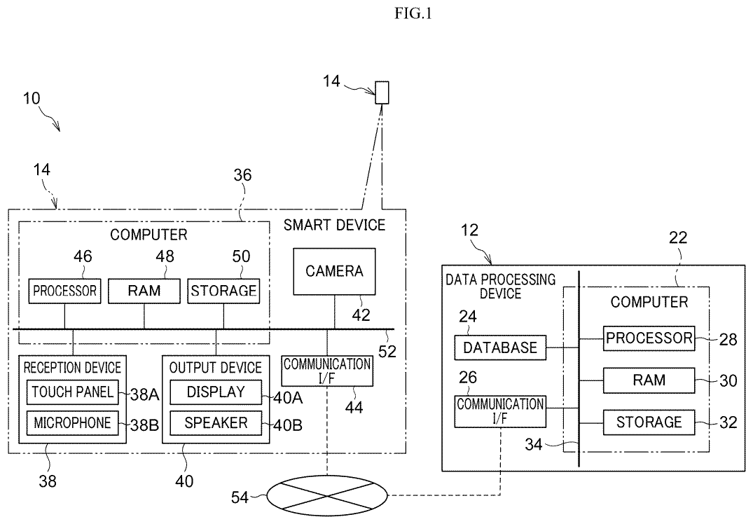

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

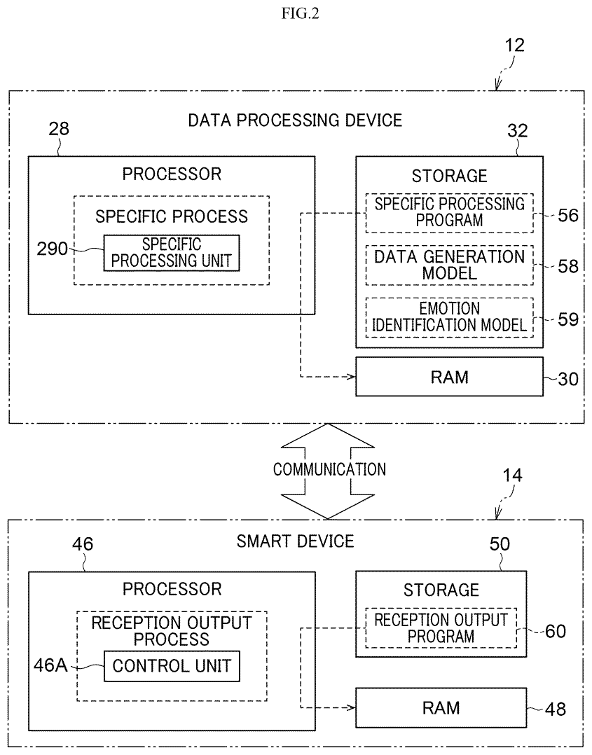

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional fraud-detection techniques for electronic funds transfer rely primarily on static rule sets, simple keyword matching, and offline analysis of transaction records. Such techniques are often implemented as post-processing checks in back-end systems and are not well suited for real-time, user-interactive environments such as automated teller machines and other transaction terminals. As a result, these techniques frequently fail to prevent sophisticated social-engineering fraud in which an attacker manipulates a user into initiating and authorizing a transaction that appears legitimate according to conventional rule-based filters.

In particular, conventional systems do not effectively utilize the rich, unstructured information contained in a user's natural-language explanations of a transaction, such as the stated relationship to a recipient, the described urgency, and contextual cues indicating third-party influence. Existing architectures typically treat such explanations, if collected at all, as free-text notes or short labels that are not computationally analyzed in depth. Consequently, current systems cannot accurately recognize nuanced fraud patterns that are expressed through combinations of linguistic features, behavioral anomalies, and known fraud indicators stored in external databases.

Moreover, traditional fraud-detection mechanisms generally operate as one-shot classifiers: once an initial risk decision is rendered, the system either allows or blocks the transaction, with little or no adaptive interaction with the user. There is no structured mechanism to use the system's risk assessment to drive a tailored dialog with the user, collect additional clarifying information, and iteratively refine the evaluation. This lack of closed-loop interaction reduces the system's ability to discriminate between genuine high-urgency transactions and fraudulent ones, and it does not assist in cooling the user's psychological state, which is often heightened by the fraudster's pressure tactics.

From a computer-technology standpoint, there is a need for an improved fraud-detection architecture in which a computing device can: (i) dynamically construct prompt sentences that condition a generative AI model with transaction context and user-specific historical data; (ii) integrate the generative AI model's semantic interpretation of user utterances with structured fraud-related information and anomaly metrics derived from transaction history; (iii) orchestrate an adaptive question-and-answer sequence with the user at a transaction terminal; and (iv) capture and reuse this interaction flow in machine-readable logs for subsequent processing, including model improvement and reporting to external entities. Existing systems do not provide such an integrated, processor-implemented workflow, and therefore fail to fully leverage advances in generative AI models and real-time, context-aware prompt engineering to improve the technical performance of fraud-risk assessment in transactional systems.

The specific processing by the specific processing unit 290 of the data processing device 12 in Example 1 is realized by the following means.

The present invention provides a server comprising a processor and a memory storing instructions which, when executed by the processor, cause the processor to acquire input information from a user of a transaction terminal, generate a prompt sentence for a generative AI model, transmit to the generative AI model an analysis request including the input information and associated transaction information, receive a response from the generative AI model, and generate a semantic interpretation result including relationship information, urgency information, and fraud risk information based on the response and content of the user's utterance; compare the semantic interpretation result with fraud-related information and transaction history information stored in at least one storage device, determine whether a current transaction corresponds to a transaction pattern that is different from a usual pattern for the user, and perform a comprehensive fraud risk evaluation of the current transaction; when the comprehensive fraud risk evaluation satisfies a predetermined condition, transmit control information including warning information and additional question prompt sentences to the transaction terminal, temporarily restrict progress of transaction processing at the transaction terminal, acquire responses of the user to the additional questions from the transaction terminal, and trigger a re-evaluation by the generative AI model based on the responses; and generate log information including the warning information, the additional questions, responses of the generative AI model, a collation result with the fraud-related information, and a final transaction selection of the user, store the log information in a storage device, and make the log information reportable to an external organization in accordance with a predetermined condition. This enables an improved computer-implemented fraud-detection workflow in which the server dynamically conditions a generative AI model through context-rich prompt sentences, integrates natural-language semantic analysis with structured fraud and history data for more accurate and timely risk evaluation, orchestrates an adaptive dialog with the user via the transaction terminal to refine the assessment and cool the user's psychological state, and records the entire interaction in machine-readable form to enhance subsequent system performance and facilitate automated reporting.

The term “user” refers to a human operator who interacts with a transaction terminal to initiate, modify, or confirm a transaction, and who provides input information including at least one of account information, transaction information, and natural-language utterances.

The term “transaction terminal” refers to an electronic device that provides a user interface for executing a transaction, the device including at least one of a display, an input device, an audio input device, and a communication interface, and being configured to communicate with a server.

The term “server” refers to an electronic apparatus including at least one processor and at least one memory, configured to execute programs that perform acquisition, analysis, control, and logging related to fraud risk evaluation for transactions.

The term “processor” refers to a hardware processing unit, such as a central processing unit or an execution core, configured to execute instructions stored in a memory to implement functions of the system, including generation of prompt sentences, analysis of responses from a generative AI model, risk evaluation, and control of a transaction terminal.

The term “memory” refers to a non-transitory computer-readable storage medium, such as a semiconductor memory device or a magnetic storage device, configured to store instructions and data used by the processor to perform the processes described herein.

The term “input information” refers to information provided by a user through the transaction terminal, including at least one of account identifiers, transaction amounts, destination identifiers, contact information, and natural-language explanations related to a transaction.

The term “transaction information” refers to structured data describing a transaction, including at least one of a transaction type, a transaction amount, a source identifier, a destination identifier, a time, and a channel through which the transaction is performed.

The term “natural-language utterance” refers to unstructured linguistic content expressed by the user, including spoken language captured by an audio input device or textual language input via a display or input device, and describing at least one of a purpose of a transaction, a relationship to a counterparty, and contextual circumstances.

The term “generative AI model” refers to a computational model trained using machine learning techniques to generate or analyze natural-language text, the model being configured to produce output such as semantic interpretations, classifications, and risk evaluations in response to prompt sentences.

The term “prompt sentence” refers to a text string constructed to condition behavior of a generative AI model, the text string including at least one of user utterance content, transaction information, anomaly information, and known fraud pattern information, and being transmitted from the server to the generative AI model as part of an analysis request.

The term “analysis request” refers to a data structure transmitted from the server to a generative AI model, including at least one prompt sentence and associated contextual information, and requesting that the generative AI model perform semantic interpretation or risk evaluation.

The term “semantic interpretation result” refers to structured data generated by the processor based on an output of the generative AI model, the structured data including at least one of relationship information, urgency information, and fraud risk information derived from a user's natural-language utterance.

The term “relationship information” refers to data indicating a relationship category between the user and a transaction counterparty, such as family, acquaintance, business partner, or unknown party, as determined from the user's natural-language utterance and analyzed by the generative AI model.

The term “urgency information” refers to data indicating a level and nature of time-related pressure associated with a transaction, such as suddenness, emergency, or imposed deadlines, as derived from the user's natural-language utterance and interpreted by the generative AI model.

The term “fraud risk information” refers to data representing an assessment of likelihood that a transaction is associated with fraudulent activity, including at least one of a categorical risk level and explanatory reasoning, as determined based on an output of the generative AI model.

The term “fraud-related information” refers to information stored in at least one storage device and associated with fraudulent or suspicious activity, including at least one of blacklists, watchlists, incident reports, and patterns of known fraud schemes.

The term “transaction history information” refers to data describing past transactions associated with a user or an account, including at least one of past transaction amounts, counterparties, frequencies, time patterns, and channels, and being used to detect deviations from usual transaction patterns.

The term “usual pattern” refers to a statistical or rule-based characterization of typical transaction behavior of a user, derived from transaction history information and used as a reference for detecting anomalous transactions.

The term “comprehensive fraud risk evaluation” refers to an aggregated assessment of fraud risk for a transaction, computed based on at least the semantic interpretation result, fraud-related information, and transaction history information, and used to determine control actions.

The term “predetermined condition” refers to a condition defined in advance by configuration data, rule sets, or program logic, specifying at least one threshold or rule under which the system changes behavior, such as triggering a warning, restricting transaction processing, or generating a report.

The term “control information” refers to data transmitted from the server to the transaction terminal, including at least one of warning information, additional question prompt sentences, and interface control commands that affect presentation to the user and the state of transaction processing.

The term “warning information” refers to message data instructing the transaction terminal to present alerts to the user about potential fraud risk, including at least one of textual warnings, audio warnings, and visual emphasis indicators.

The term “additional question prompt sentence” refers to a prompt sentence generated for presentation to the user via the transaction terminal, configured to elicit further clarifying information regarding circumstances of the transaction for use in fraud risk re-evaluation.

The term “temporarily restrict progress of transaction processing” refers to controlling a transaction terminal such that at least one transaction operation, including final execution of the transaction, is disabled, delayed, or conditioned upon completion of additional steps, including user responses to questions.

The term “re-evaluation by the generative AI model” refers to a subsequent fraud risk analysis using the generative AI model, performed after acquisition of additional user responses and based on updated prompt sentences and contextual data.

The term “log information” refers to machine-readable data generated and stored by the server, including at least the warning information, the additional questions, responses of the generative AI model, collation results with fraud-related information, and the user's final transaction selection.

The term “external organization” refers to an entity separate from the operator of the system, including at least one of a regulatory authority, a law-enforcement body, or another trusted institution, that receives reports generated from the log information under the predetermined condition.

Server, terminal, and user cooperate to implement embodiments of the present invention. In the following description, a “server” denotes one or more computing devices, a “terminal” denotes a transaction terminal such as an automated teller machine or kiosk, and a “user” denotes a human operator interacting with the terminal.

Server comprises at least one processor and at least one memory. In one embodiment, server uses a general-purpose processor such as a multi-core central processing unit executing an operating system such as a UNIX-compatible operating system. Server further includes a network interface, a non-volatile storage device such as a magnetic disk drive or a solid-state drive, and optionally a hardware accelerator such as a graphics processing unit for executing neural-network inference. Server executes a set of software modules including a communication module, a natural-language pre-processing module, a generative AI inference module, a rule-based risk evaluation module, a database access module, and a logging module. These modules may be implemented using a programming language such as C++, Java, or Python, and may run within a middleware framework such as an application server or a microservice container platform.

Terminal comprises an input/output subsystem that includes at least a display unit, an input unit, an audio input unit, and a communication interface. In a typical configuration, terminal uses an embedded operating system such as an embedded Linux system. Terminal includes a touch-sensitive panel as the display, a numeric keypad, a card reader, a cash handling mechanism, a microphone, a loudspeaker, and a network communication controller. Terminal executes an application program that provides graphical user interface screens, captures user operations, encodes user input as digital data, and exchanges messages with server via a secure communication protocol such as Transport Layer Security applied to a packet-switched network.

User operates terminal by inserting a card, entering authentication information, inputting transaction parameters, and entering natural-language explanations describing a transaction. User reads or listens to prompts displayed or spoken by terminal and provides responses that are processed by server.

Server generates and executes a program for context-aware fraud risk evaluation using a generative AI model. In one embodiment, server stores in memory a generative AI model implemented as a transformer-based neural network having multiple attention layers, feed-forward layers, and layer normalization units. The generative AI model is trained on a corpus of text including conversational dialogues and descriptions of financial transactions. During operation, server invokes this model to produce structured outputs such as relationship categories, urgency levels, and fraud risk scores.

Server uses a specific data flow to apply the generative AI model to user input. Server receives from terminal a transcript of user utterances or a text entry, and generates a prompt sentence that conditions the generative AI model. For example, server constructs a prompt sentence as follows:

“You are a fraud-detection assistant for ATM transfers. The user said: ‘I am sending money to my nephew because he suddenly called me and said he needs it for an emergency.’ Analyze the purpose of this transfer, identify the relationship, and evaluate whether this situation is suspicious. Output: (1) relationship, (2) urgency level, (3) fraud risk level (low/medium/high), and (4) brief reasoning.”

Server embeds this prompt sentence and contextual transaction information into a token sequence and supplies it to the input of the generative AI model. The generative AI model internally performs a series of tensor operations: token embeddings are mapped into high-dimensional vectors, self-attention layers compute weighted combinations of token representations using learned query, key, and value matrices, and feed-forward layers apply non-linear transformations to capture complex linguistic patterns. The model generates output tokens representing a structured or semi-structured response. Server parses the response using a deterministic parser or regular-expression rules to extract explicit fields such as “relationship: nephew,” “urgency: high,” and “risk: high.”

Server stores the extracted fields as part of a semantic interpretation result in a data structure such as a key-value map or a structured record in volatile memory. The semantic interpretation result includes relationship information, urgency information, and fraud risk information. Server thereby converts unstructured natural-language utterances into machine-readable features that can be combined with structured fraud-related information and transaction history information.

Server accesses one or more databases via the database access module. In one embodiment, server communicates with a relational database management system storing fraud-related information, such as blacklists of accounts and contact identifiers associated with past fraudulent activity, and records of known fraud schemes. Server also accesses a transaction history database that records past transactions for each user or account, including transaction amounts, time stamps, counterparties, and channels. Server constructs query statements to retrieve, for example, all past transactions for the current user within a predetermined period and summary statistics such as typical amount ranges and common counterparties. Server performs algorithmic processing on the transaction history information. In one embodiment, server computes for each new transaction a deviation score representing how much the new transaction differs from the user's usual pattern. Server can compute the deviation score using a statistical distance measure, such as a z-score of transaction amount relative to past mean and variance, or a clustering-based anomaly score. Server normalizes the deviation score into an anomaly metric and stores it as one of the features used in risk evaluation.

Server combines the semantic interpretation result, the fraud-related information, and the transaction history information in a rule-based risk evaluation module. This module can be implemented as a decision tree, a rule engine, or a scored formula. For example, server applies rules such as: if the generative AI model indicates a family relationship and high urgency and if the destination account appears in a blacklist, then assign a high comprehensive fraud risk evaluation; if the generative AI model indicates friendship and high urgency and the anomaly score of the amount exceeds a threshold, assign a medium-high risk; if the generative AI model indicates low urgency and no blacklist match, and the transaction is within usual pattern, assign low risk. The use of both learned semantic features from the generative AI model and deterministic rule evaluation enables improved discrimination compared to conventional keyword-based systems.

Server generates prompt sentences not only for the generative AI model, but also for questions presented to user by terminal. For example, server may generate the following prompt sentences:

“Please explain the purpose of this transfer in detail.”

“What is your relationship to the recipient of this transfer?”

“Is this transfer urgent, and why is it urgent?”

“Did someone instruct you by phone to make this transfer?”

“Did the caller ask you to keep this transfer secret from your family or from the bank staff?” Server sends these prompt sentences to terminal as message payloads. Terminal displays the prompt sentences on the touch-sensitive display and may convert them into audible speech using a text-to-speech engine. User responds by speaking into the microphone or entering text via the input interface. Terminal samples audio signals from the microphone and encodes them as digital audio data. Terminal then transmits the audio data or text data to server. Server uses an automatic speech recognition engine to convert audio data into text, which then becomes part of the input for the generative AI model. This integration of TTS and ASR with the generative AI model enables an end-to-end, machine-interpretable dialog flow.

Server does not merely automate a human operator's manual analysis, but performs a series of technical steps that improve computer-implemented fraud detection. In particular, server executes a pipeline that compresses high-dimensional linguistic signals into a feature set that is specifically tailored for fraud risk evaluation, such as relationship categories and urgency levels. Server leverages pre-computed embeddings and vectorized computations on modern processors, thereby reducing the time required to analyze user utterances compared to manual review. The use of a transformer-based generative AI model trained with a large corpus permits the system to recognize complex linguistic patterns that simple keyword search cannot capture, thereby improving the accuracy and reducing false negatives and false positives.

Server is configured to train and fine-tune the generative AI model in a pre-deployment phase. During training, server iteratively updates parameter matrices of the model using a supervised learning method such as gradient descent. Server defines a loss function that measures error between model outputs (e.g., predicted risk categories) and ground-truth labels obtained from confirmed fraud and non-fraud cases. Server computes gradients of the loss function with respect to model weights using backpropagation, and updates weight values according to an optimization algorithm such as stochastic gradient descent with momentum or an adaptive learning-rate method. Server may perform data augmentation by paraphrasing user explanations, injecting various urgency expressions, and simulating diverse fraud scenarios, so that the generative AI model learns robust features. As a result, once deployed, the model can compute risk assessments quickly and accurately for unseen input sentences.

Server implements non-conventional rules and processing sequences that are not simple business rules. For example, server not only evaluates risk once, but initiates a closed-loop process in which the initial risk evaluation determines which additional questions are posed to user, which in turn produce new utterances that are fed back into the generative AI model for re-evaluation. This iterative process increases the information content available to the classifier without requiring manual analyst intervention. The rules that determine which follow-up questions to ask can depend on combinations of semantic features (e.g., presence of law-enforcement references in the user explanation), anomaly scores, and external blacklist hits. This multi-dimensional rule application is technically implemented in the computer system as conditional branching and dynamic message generation, resulting in improved precision and recall of fraud detection.

Server controls terminal based on the comprehensive fraud risk evaluation. When server deems risk above a threshold, server transmits control information instructing terminal to modify its user interface state. For example, server can cause terminal to disable a “Confirm Transfer” button, activate a “Cancel” button, and display a warning message such as “This transfer may be fraudulent. Please reconfirm.” Terminal enforces these instructions by changing the state of graphical elements on the display and by altering its internal state machine so that it does not send a transaction execution request to the core banking system while the warning is active. In this way, the fraud-risk evaluation is tightly coupled to control of physical transaction-execution machinery, including cash dispensers and account-authorization circuits accessible through the terminal.

User experiences an interactive dialog that is automatically adapted according to the server's analysis. In one example, user attempts to send a large amount of funds and verbally explains, “I am sending money to a friend because he suddenly needs to repay a loan.” Server converts this utterance into text and constructs a prompt sentence for the generative AI model: “Analyze the following transfer explanation and evaluate fraud risk: ‘I am sending money to a friend because he suddenly needs to repay a loan.’ Output a risk level (low/medium/high) and a short reason.”

Server receives from the generative AI model an output indicating a medium to high risk and a rationale that urgent, unexpected payment for a third party is a common fraud pattern. Server then queries fraud-related databases and discovers that the destination contact information has been reported in prior incidents. Based on this combination of semantic cues and database hits, server determines that the comprehensive risk is high. Server instructs terminal to show a strong warning and to present additional questions, such as “Did someone instruct you by phone to make this transfer?” and “Did the caller ask you to keep this transfer secret?” If user answers “yes” to such questions, server generates another prompt sentence that includes the follow-up answers, and re-evaluates the risk with the generative AI model. In response, server may keep the transaction blocked and recommend that user contact law-enforcement authorities.

This architecture improves computer technology in several ways. Server reduces computational load by using hierarchical processing: inexpensive statistical checks on transaction history quickly filter out clearly low-risk cases, while only potentially risky cases are processed by the more compute-intensive generative AI model. This layered approach reduces average processing time and network load between server and any external model-hosting services. Additionally, because server encodes semantic interpretation results as compact structured fields rather than storing entire transcripts, the system improves data management efficiency and enables faster index-based searches in log databases.

Server also achieves improved accuracy by exploiting the generative AI model not as a generic chatbot, but as a specialized classifier directed by carefully designed prompt sentences that include explicit output formatting instructions. This avoids ambiguous natural-language responses and allows deterministic parsing of model outputs. The combination of this specialized prompting, structured parsing, and rule-based post-processing constitutes a technical improvement over simple end-to-end natural-language interfaces because it reduces error propagation and supports verifiable decision logic.

Server logs interaction data in a machine-readable form suitable for subsequent batch analysis and model retraining. For each relevant transaction, server stores the prompt sentences sent to the generative AI model, the model's outputs, the semantic interpretation result, the fraud-related database results, terminal control actions, and user responses. Later, server can run offline processes that scan these logs to discover patterns where the initial risk assessment was later confirmed as correct or incorrect, and can update rule thresholds or fine-tune the generative AI model accordingly. This continuous feedback loop enhances the performance of the system over time.

In alternative embodiments, server may replace the transformer-based generative AI model with another deep-learning architecture such as a recurrent neural network with attention or a convolutional neural network specialized for text classification. Server may also deploy a hybrid model in which a pre-trained language model generates contextual embeddings, and a smaller task-specific neural network maps these embeddings to fraud risk scores. In some embodiments, server may execute inference on a dedicated accelerator to further reduce latency. In other embodiments, server may compress the generative AI model using quantization or knowledge distillation to reduce memory footprint and communication overhead.

Terminal can likewise vary in implementation. In some embodiments, terminal is a fixed self-service kiosk integrated into a financial institution's branch. In other embodiments, terminal is a mobile communication device executing an application that interacts with server over a wireless network. Regardless of physical form, terminal implements the same logical interface for receiving warning messages, presenting prompt sentences, and relaying user responses back to server.

Through these embodiments, server, terminal, and user interactions collectively provide a concrete implementation of a system that uses a generative AI model and context-rich prompt sentences to control transaction terminals in real time. The system does not merely automate a preexisting manual workflow but introduces new computational structures and processing sequences that enable higher-precision, lower-latency fraud detection and technically improve use of computer resources for evaluating and mitigating fraud risk.

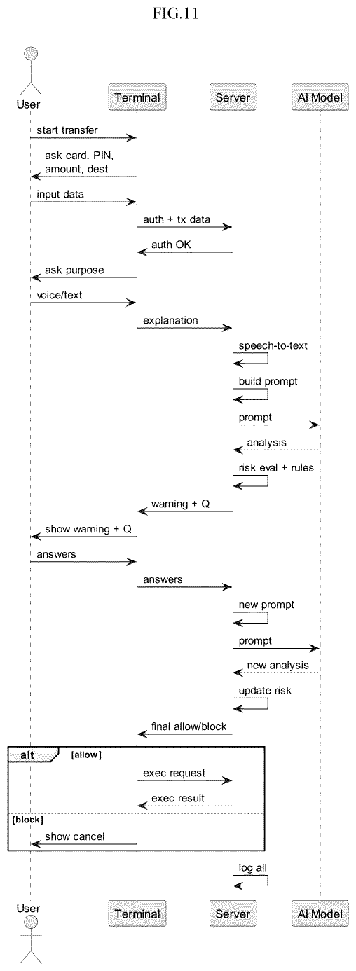

The following describes the processing flow using FIG. 11.

### Step 1:

Terminal presents a transaction start interface and acquires basic transaction input from user. Terminal displays screens for card insertion, personal identification input, destination identifier input, and transfer amount input.

User inserts a card, enters an authentication code, and uses the touch panel or keypad to input a destination identifier and a transfer amount.

Input: physical card, authentication code, destination identifier, transfer amount. Terminal converts the physical and touch operations into digital data structures (for example, an authentication record and a preliminary transaction record), performs local format validation and masking of sensitive data, and outputs a structured message containing the authentication information and basic transaction information to server via a secure communication channel.

### Step 2:

Server authenticates user and establishes a transaction session.

Server receives the authentication information and basic transaction information from terminal, decrypts or verifies the authentication code using a security module, and queries an account database to validate the user identity and available balance.

Input: authentication record, preliminary transaction record.

Server executes comparison and lookup operations against stored account identifiers and credentials, updates or creates a session object in volatile memory, associates the basic transaction information with the session, and outputs an authentication result and a session identifier back to terminal.

### Step 3:

Terminal prompts user for a natural-language explanation of the transaction.

Terminal, upon receiving the authentication result and session identifier, displays a screen asking for a purpose and a relationship description, for example: “Please explain the purpose of this transfer in detail.” and “What is your relationship to the recipient of this transfer?” User chooses voice input or text input and expresses an explanation, such as “I am sending money to my nephew because he suddenly called me and said he needs it for an emergency.”

Input: session identifier, display templates, user utterance or text entry.

Terminal renders prompt sentences on the display, records audio signals from the microphone when voice input is used, digitizes the audio into encoded audio data, or encodes text input into a text string, and outputs a message including the session identifier and the user explanation data to server.

### Step 4:

Server performs speech recognition and text pre-processing.

Server receives encoded audio data or a text string as the user explanation. If audio data is present, server invokes a speech recognition engine to convert the audio waveform into a text transcript.

Input: user explanation message including session identifier and audio or text content.

Server maps audio frames to phonetic units, computes likelihoods using an acoustic model, applies a language model to generate a text sequence, normalizes punctuation and casing, removes extraneous fillers, segments the text into tokens using a tokenizer, and outputs a cleaned natural-language text representation associated with the session.

### Step 5:

Server constructs a context-rich prompt sentence for the generative AI model.

Server gathers the cleaned text, basic transaction information (such as amount and destination identifier), and transaction history features for the user from internal databases.

Input: cleaned user text, transaction record, user history summary.

Server executes concatenation and template-filling operations to build a prompt sentence, for example:

“You are a fraud-detection assistant for ATM transfers. The user said: ‘I am sending money to my nephew because he suddenly called me and said he needs it for an emergency.’ The transfer amount is 1,000,000. Based on the user's past transactions, this amount is higher than usual. Analyze the purpose of this transfer, identify the relationship, and evaluate whether this situation is suspicious. Output: (1) relationship, (2) urgency level, (3) fraud risk level (low/medium/high), and (4) brief reasoning.”

Server then outputs a formatted analysis request that includes the prompt sentence and context fields to the generative AI model interface.

### Step 6:

Server executes inference using the generative AI model and generates a semantic interpretation result.

Server passes the prompt sentence to a generative AI model implemented as a neural-network engine, which runs on the same server or on a connected inference service.

Input: prompt sentence and context metadata.

Server encodes the prompt sentence into tokens, maps tokens to numeric embeddings, applies the generative AI model's layers (including attention and feed-forward operations) to compute output token probabilities, decodes the output tokens into a response string, and parses the response to extract structured fields such as “relationship,” “urgency level,” and “fraud risk level.”

Server aggregates these fields into a semantic interpretation record and outputs this record, associated with the session, to the risk evaluation module.

### Step 7:

Server collates the semantic interpretation result with fraud-related information and transaction history.

Server accesses external and internal databases containing fraud-related entries (for example, blacklists) and detailed transaction history information.

Input: semantic interpretation record, destination identifier, user identifier.

Server performs database queries and joins to retrieve any fraud incidents associated with the destination identifier, calculates anomaly scores for the current transaction amount and pattern compared to historical distributions, and merges these findings with the semantic interpretation record.

Server outputs a combined feature set including semantic features, blacklist flags, and anomaly metrics to the comprehensive risk evaluation process.

### Step 8:

Server computes a comprehensive fraud risk evaluation and determines control actions. Server feeds the combined feature set into a rule-based or model-based evaluation function.

Input: semantic features, blacklist flags, anomaly metrics.

Server evaluates logical conditions and numeric thresholds, applies weighted scoring formulas or decision-tree branches, computes an overall fraud risk score and category (for example, low, medium, or high), and determines corresponding control actions such as “allow transaction,” “issue warning and gather more information,” or “block transaction temporarily.”

Server outputs a control decision object that includes the risk category, recommended user prompts, and interface control flags.

### Step 9:

Server generates warning messages and additional question prompt sentences for user.

Server, based on the control decision, composes human-readable messages and follow-up questions tailored to the detected risk pattern.

Input: control decision object, semantic explanation, fraud indicators.

Server assembles warning texts such as “This transfer may be fraudulent. Please reconfirm.” and generates additional prompt sentences like “Did someone instruct you by phone to make this transfer?” and “Did the caller ask you to keep this transfer secret from your family or bank staff?”

Server outputs a response message containing these warnings, question texts, and user interface control flags to terminal.

### Step 10:

Terminal presents warnings and questions, and collects user responses.

Terminal receives the response message and updates the user interface accordingly.

Input: warnings, question texts, interface control flags.

Terminal displays the warning message prominently, plays an audio warning through a speech-synthesis function if configured, disables confirmation buttons as specified, and renders the additional questions with selectable answer options or free-text input fields. User reads or listens to the warnings and questions and then enters responses, for example selecting “Yes” to “Did someone instruct you by phone to make this transfer?” or speaking additional explanations.

Terminal encodes these responses into structured data or audio data, associates them with question identifiers and the session identifier, and outputs the aggregated user response message to server.

### Step 11:

Server re-analyzes user responses with the generative AI model and updates the risk evaluation.

Server receives the aggregated user response message and uses speech recognition again if audio is included, producing additional text strings.

Input: previous semantic interpretation, additional user answers, transaction context.

Server constructs a new prompt sentence that includes both the original explanation and the new answers, such as:

“You are a fraud-detection assistant for ATM transfers. The user initially said: ‘I am sending money to my nephew because he suddenly called me and said he needs it for an emergency.’ The user answered additional questions as follows: Q1: ‘Did someone instruct you by phone?’-> ‘Yes, the caller claimed to be from the police and told me to move my money.’ Q2: ‘Did they ask you to keep this secret?’-> ‘Yes.’ Based on all information, update the fraud risk level and explain why.”

Server submits this updated prompt sentence to the generative AI model, obtains a refined response, parses the updated relationship, urgency, and risk fields, recomputes the comprehensive fraud risk evaluation using the same or adjusted rules, and outputs an updated control decision.

### Step 12:

Server instructs terminal regarding final transaction permission or prohibition and logs interaction data.

Server, based on the updated control decision, determines whether to maintain a block, recommend cancellation, or allow execution of the transaction.

Input: updated control decision, session state.

Server constructs a final control message with explicit execution permissions or prohibitions, final warning or confirmation texts, and logging directives. Server records in a log storage system the full interaction data including prompt sentences sent to the generative AI model, model responses, semantic interpretation records, fraud database matches, user responses, and final transaction outcome.

Server outputs the final control message to terminal and stores an acknowledgment of the log entries.

### Step 13:

Terminal executes or cancels the transaction according to server instructions and provides feedback to user.

Terminal receives the final control message and checks the execution permission flag.

Input: final control message, current transaction data.

If execution is allowed, terminal sends a transaction execution request to the core transaction infrastructure, waits for a completion response, and displays a success message and any advisory note to user. If execution is prohibited or user has been advised to cancel, terminal keeps confirmation controls disabled, displays a cancellation or advisory message, and allows user to terminate the session.

Terminal outputs a completion or cancellation status back to server, ensuring that the session is correctly closed and that any required receipts or records are generated for user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional security systems that monitor network connections typically rely on static rule sets, signature-based detection, or simple statistical anomaly detection. Such systems are often implemented as fixed logic on a server that evaluates network addresses, ports, and known blacklists. These conventional approaches suffer from several technical limitations.

First, conventional systems have difficulty adapting to complex and evolving connection patterns. When a connection pattern deviates only slightly from a predefined baseline, traditional rule engines cannot reliably distinguish between benign atypical behavior, such as overtime work or travel, and truly malicious behavior, such as credential theft or remote command-and-control. As a result, conventional systems either generate excessive false positives, which overload processing resources and operator attention, or fail to detect sophisticated threats, which undermines the effectiveness of the protection.

Second, conventional systems do not effectively utilize rich context about user behavior and device usage patterns in a way that can be flexibly updated at runtime. While some systems may store logs of past connections, the server often processes this history only via rigid threshold checks or simple statistical deviations. This leads to a technically suboptimal use of available data, because the server cannot dynamically synthesize complex relationships among user behavior history, geographic patterns, device changes, and external threat intelligence. Consequently, the quality of the risk assessment performed by the server is limited, and the server cannot efficiently allocate computing and network control resources based on nuanced risk evaluation.

Third, conventional systems provide limited interaction between automated detection and human operators. When a suspicious connection is detected, many systems either block it automatically or provide only a minimal alert without a mechanism to refine the machine's assessment based on additional information from the user. The lack of an integrated loop, in which the server can request clarifying context from the user and feed this context back into the machine evaluation, results in technically inefficient workflows: the server cannot update its internal state or its decision in a structured way, and the overall system may continue to consume resources on redundant checks or incorrect enforcement.

Fourth, existing systems that attempt to use machine learning models for security often treat the models as black boxes that receive low-level numerical features. The models do not receive rich, structured natural language prompts that explicitly encode both current connection attributes and historical behavior patterns in a human-interpretable format. As a result, the server cannot leverage generative AI models that excel at processing natural language and complex contextual descriptions. This limits the server's capability to generate explainable risk assessments and to systematically integrate external threat intelligence and user feedback.

Therefore, there is a need for a technical mechanism by which a server can (i) dynamically construct prompt sentences that encode detailed connection information and historical behavior information, (ii) interact with a generative AI model to obtain structured evaluation information and numerical risk information, (iii) automatically correlate this information with external fraud-related databases in real time, and (iv) enforce connection control in a way that can be refined through structured interaction with a user. By solving these technical problems, the server can improve the accuracy and efficiency of risk assessment, reduce unnecessary network restrictions, and provide a more adaptive and explainable security control architecture.

The specific processing by the specific processing unit 290 of the data processing device 12 in Application Example 1 is realized by the following means.

The present invention provides a server comprising a processor configured to acquire behavior information including connection information from an information processing terminal that attempts to connect to a communication network, generate a prompt sentence for a generative AI model based on the behavior information, input the prompt sentence into the generative AI model, receive evaluation information and numerical risk information from the generative AI model, correlate the evaluation information and the numerical risk information with fraud-related information obtained in real time from one or more external storage devices, determine a possibility of a wrongful act based on the correlation, output control information to a communication control device to temporally restrict or permit the connection according to the possibility, present inquiry information and explanatory information to a user via a user display device to obtain additional information from the user when the possibility exceeds a predetermined criterion, generate an additional prompt sentence including the additional information, input the additional prompt sentence into the generative AI model to obtain re-evaluation information, update the determination of the possibility based on the re-evaluation information, and store, as history information, at least the connection information, the prompt sentences, the evaluation information, the numerical risk information, the correlation results, the control information, and user responses. This enables the server to technically improve connection risk assessment by integrating generative AI-based natural language evaluation, real-time external threat intelligence, and structured user feedback into a unified control loop, thereby enhancing detection accuracy, reducing false positives, optimizing resource usage in network control, and providing explainable and adaptive security behavior at the system level.

The term “system” refers to a collection of hardware components and software components that cooperate to perform network security monitoring, risk evaluation, and connection control processing as recited in the claims.

The term “server” refers to an information processing apparatus that includes at least one processor, a memory, and one or more communication interfaces, and that executes programs to perform the acquisition, analysis, correlation, control, and recording operations described in the claims.

The term “processor” refers to one or more hardware processing units, such as a central processing unit or a hardware logic circuit, that execute instructions stored in a memory to carry out the functions attributed to the processor in the claims.

The term “communication network” refers to any wired or wireless data communication infrastructure, including local networks and wide area networks, through which the information processing terminal attempts to establish a connection.

The term “information processing terminal” refers to any endpoint device capable of communicating over the communication network, such as a computing device, a mobile device, or an embedded device, that initiates a connection to the server or to a protected resource.

The term “behavior information” refers to information representing activity related to a connection attempt by the information processing terminal, including current connection information and one or more historical usage characteristics associated with a user or the information processing terminal.

The term “connection information” refers to data describing a specific connection attempt or communication session, including at least one of a network address, a device identifier, a communication protocol, a connection time, and a geographic location associated with the information processing terminal.

The term “network address” refers to an address used in a communication protocol to identify a source or destination within a communication network, such as an Internet Protocol address.

The term “device identifier” refers to information used to distinguish one device from another in a networked environment, such as a media access control address, a hardware identifier, or a software-based identifier.

The term “communication protocol” refers to a defined set of rules and formats used to control data exchange between devices in the communication network, such as a transport protocol or an application protocol.

The term “connection time” refers to temporal information associated with the connection, including at least a timestamp indicating when the connection was initiated, detected, or processed by the server.

The term “geographic location” refers to position information associated with the connection, which is derived from the network address or other attributes and may include data such as a country, region, or city.

The term “history information” refers to stored data representing past behavior of a user or an information processing terminal, including at least one of past connection times, usual geographic regions, typical communication methods, and previous device identifiers.

The term “prompt sentence” refers to a sequence of characters arranged in a natural language or structured text format that is generated by the processor and provided as input to the generative AI model to request evaluation or analysis of a connection.

The term “additional prompt sentence” refers to a prompt sentence that is generated by the processor using additional information obtained from a user in response to an inquiry, and that is input to the generative AI model to obtain re-evaluation information.

The term “generative AI model” refers to a machine learning model that is trained to generate or process natural language outputs in response to input text, and that, when provided with a prompt sentence, outputs evaluation information and numerical risk information relating to a connection.

The term “evaluation information” refers to natural language output from the generative AI model that describes at least a purpose of a connection, a reliability of an information processing terminal, or a degree of deviation from a normal behavior pattern.

The term “numerical risk information” refers to quantitative output from the generative AI model, such as a numerical value or score, indicating a risk level or likelihood that a given connection is associated with a wrongful act.

The term “re-evaluation information” refers to evaluation information and numerical risk information output by the generative AI model in response to an additional prompt sentence that includes additional information obtained from a user.

The term “normal behavior pattern” refers to a baseline representation of typical activity derived from history information, including at least usual connection times, common geographic locations, usual communication methods, or commonly used devices for a given user or terminal.

The term “fraud-related information” refers to information stored in an external storage device that indicates known or suspected involvement of network addresses, device identifiers, or other communication identifiers in fraudulent activities or other wrongful acts.

The term “communication identifier information” refers to lists or sets of communication-related identifiers, such as network addresses or device identifiers, that are associated with past malicious or suspicious activity and are stored for comparison with current connection information.

The term “external storage device” refers to a storage resource that is separate from the main memory of the server, and that stores fraud-related information and communication identifier information, and is accessible to the server via a communication network.

The term “encrypted communication” refers to a communication method in which data transmitted between the server and the external storage device is transformed using a cryptographic algorithm so as to provide confidentiality and integrity protection.

The term “possibility of a wrongful act” refers to an assessment made by the processor, based on evaluation information, numerical risk information, and comparison results with fraud-related information, that indicates a likelihood that a connection is associated with fraud or other unauthorized activity.

The term “predetermined criterion” refers to a threshold or rule, stored in a memory and used by the processor, for determining when the possibility of a wrongful act is high enough to trigger temporary restriction, additional inquiries, or further control actions.

The term “communication control device” refers to a device or functional module that applies control to network traffic, such as a firewall, a gateway, or a router, and that restricts, permits, or modifies connections in response to control information from the server.

The term “control information” refers to data generated by the processor that instructs the communication control device to perform specific actions on network traffic, such as temporarily restricting, permitting, or permanently blocking a connection.

The term “user display device” refers to an output device or interface that presents information to a human user, such as a graphical user interface on a computing device, and that allows the user to view alerts, explanations, and inquiry information.

The term “notification information” refers to information that indicates to a user that a connection may be associated with a wrongful act and that may include summaries of evaluation information or risk levels.

The term “explanation information” refers to information presented to a user that includes at least a portion of the evaluation information from the generative AI model and that explains reasons for a risk assessment or for a control action.

The term “inquiry information” refers to information presented to a user that prompts the user to provide additional information regarding a connection, such as the purpose of the connection, a relationship with the information processing terminal, or a necessity of the connection.

The term “permission information” refers to input data received from a user that indicates authorization to permit or continue a connection that has been restricted or flagged as potentially wrongful.

The term “blocking information” refers to input data received from a user that indicates a decision to block, terminate, or continue to restrict a connection that has been flagged as potentially wrongful.

The term “restriction state of the connection” refers to an enforced condition in which a connection is limited, temporarily blocked, or otherwise controlled by the communication control device according to control information from the server.

The term “history information for later analysis” refers to stored records that include at least connection information, prompt sentences, evaluation information, numerical risk information, comparison results, control information, and user responses, and that are retained for subsequent review, tuning, or forensic analysis.

In one embodiment, a server executes a program stored in a non-transitory computer-readable medium to realize the functions of the processor recited in the claims. The server includes at least one central processing unit (CPU), at least one memory device such as a random access memory, one or more storage devices such as a magnetic disk or a solid-state drive, and one or more communication interfaces connected to a communication network. The server further cooperates with a communication control device, such as a firewall or a gateway, and with one or more external storage devices that store fraud-related information via encrypted communication.

The server runs an operating system such as a general-purpose server operating system and executes application programs implementing modules corresponding to the behavior information acquisition function, the prompt generation function, the generative AI model interface function, the evaluation aggregation function, the external database access function, the control function for the communication control device, the user interface function, and the logging function. The server may further use a database management system such as a relational database management system to store history information, connection information, and intermediate results.

The terminal operates as an information processing terminal, such as a client computer, a portable computing device, or a specialized industrial device, that establishes a communication session with the server or with a protected resource under the control of the server. The terminal includes a processor, a memory, a display device, input devices, and a communication interface. The terminal sends connection requests and connection parameters to the server over the communication network and presents notification information, explanation information, and inquiry information generated by the server to a user.

The user operates the terminal to perform normal tasks such as accessing protected resources and, in response to alerts or inquiries presented on the display device, provides permission information, blocking information, and additional explanatory information regarding the purpose and necessity of a connection. The user's input is transmitted from the terminal to the server using an application-level protocol and is processed by the server as part of the feedback loop described in the claims.

### 1. Hardware and Software Configuration for Behavior Information Acquisition and Data Structures

The server acquires behavior information including connection information from the terminal through one or more communication interfaces. The server uses a packet capture and session inspection module, which may be implemented using packet filtering mechanisms in the operating system kernel and an intrusion detection or monitoring engine. The server extracts connection information such as network addresses, device identifiers, communication protocols, connection times, and geographic locations inferred from the network addresses using an address-to-location mapping database.

The server stores the connection information and associated behavior information in a structured data store. In one embodiment, the server uses relational tables with fields including, for example, connection identifier, user identifier, terminal identifier, source network address, destination network address, protocol type, port numbers, connection start time, connection end time, geographic location code, device identifier, and user agent information received from the terminal. The server further stores history information such as previous connection records, typical connection time bands for each user, usual geographic regions from which each user connects, typical communication methods, and previous device identifiers used by each user.

The server maintains indexes over at least user identifiers, terminal identifiers, network addresses, and time ranges to allow efficient retrieval of past records during evaluation. By maintaining these specific data structures and indexes, the server reduces query latency when constructing prompt sentences and computing derived features, which contributes to improved processing speed and reduced computational overhead compared to ad hoc log scanning.

### 2. Generative AI Model Integration and Prompt Sentence Construction

The server integrates a generative AI model to perform natural-language-based evaluation of the connection. In one embodiment, the generative AI model is a multi-layer neural network having a transformer-based architecture. The neural network includes an input embedding layer that converts tokens of a natural language prompt into vector representations, multiple self-attention layers that compute context-dependent representations across the tokens, feed-forward layers that nonlinearly transform the representations, and an output layer that produces probability distributions over output tokens. The model is trained in advance on a large corpus of natural language text and further fine-tuned on domain-specific security logs and incident descriptions.

The server constructs a prompt sentence for the generative AI model by combining current connection information and retrieved history information into a structured natural language description. The server uses an internal template that specifies fields such as user identifier, source network address, terminal device description, connection time, usual login window, usual countries, known devices, and recent security history. The server fills these fields with actual values and produces a coherent text describing the connection and context. For example, the server generates the following prompt sentence:

You are a security analysis assistant.

Evaluate the risk of the following network access.

### Current Access:

User ID: u12345
Source IP: 198.51.100.10
Country: Country X
Device MAC: 00:11:22:33:44:55
User-Agent: Mozilla/5.0 (Windows 10; ×64)
Access time: 02:05 local time

### User's Normal Pattern:

Normal login window: 09:00-18:00 on weekdays
Normal countries: Country A, Country B
Known devices:
   MAC 11:22:33:44:55:66 with Windows 10
   MAC AA:BB:CC:DD:EE:FF with macOS
Recent security history: no confirmed incidents in the last 90 days.

### Questions:

1. What is the likely purpose of this access?
2. Is the source device trustworthy (“trustworthy”, “suspicious”, or “unknown”)?
3. Is this access within normal working hours (“yes” or “no”)?
4. Is the geographic location within the normal range (“yes” or “no”)?
5. Provide an overall risk_score between 0 and 1.

Please respond in JSON with fields:
purpose, trust_level, within_hours, within_geo_range, risk_score, explanation.

The server uses such a prompt sentence to present to the generative AI model a structured set of features and evaluation questions in natural language form. By encoding both current and historical data into a textual representation, the server enables the generative AI model to perform a complex, context-aware reasoning process that is not easily expressible as a fixed rule set. The server thereby improves the flexibility and expressiveness of the evaluation procedure without requiring manual rule maintenance.

In another example, the server generates a prompt sentence for a borderline case: This access appears slightly unusual but not clearly malicious.

Please carefully evaluate the following information.

### Access:

User ID: u67890
Source IP: 203.0.113.50 (Country B)
Access time: 19:30 local time

### Normal Pattern:

Usual login time: 09:00-18:00
Normal countries: Country B

Question: Is this access likely benign overtime work, or is it suspicious?

Answer with: “benign_overtime” or “suspicious” and explain briefly.

The server can vary the prompt sentences according to the connection context and internal policy thresholds.

### 3. Feature Generation and Evaluation Computation

The server does not merely send raw fields to the generative AI model. The server first computes derived features that quantify deviations from normal behavior. For example, the server computes the difference between the current connection time and the center of the user's normal login window, the count of distinct geographic regions used in the last specified period, a binary indicator of whether the device identifier has been previously used by the same user, and a measure of the difference between the current user agent string and typical strings stored in history information.

The server aggregates these derived features into text phrases inserted into the prompt sentence. For example, the server writes phrases such as “The access occurs 6 hours later than the user's normal latest login time” or “The device has not been seen before for this user.” By explicitly representing such features in the prompt sentence, the server enables the generative AI model to reason over both symbolic and quantitative aspects of the behavior.

The generative AI model outputs evaluation information in natural language, including a description of the likely purpose of the connection, an assessment of the reliability of the terminal, and an explanation of whether the behavior is consistent with past patterns. The generative AI model further outputs numerical risk information, such as a risk score in the range from zero to one. Internally, the generative AI model computes these outputs by performing matrix multiplications and non-linear transformations over the embedded vector representations and by sampling or selecting the most likely output tokens according to the probability distributions learned during training.

In one embodiment, during training of the generative AI model, the server (or a training system) uses supervised learning with labeled security cases. The model is trained to minimize a loss function, such as a cross-entropy loss for classification tokens and a mean squared error loss for numerical risk scores, using gradient descent and backpropagation through the transformer layers. Weights of the neural network are updated based on gradients computed using batches of training examples. By training the model in this way, the generative AI model internalizes complex relationships between textual descriptions of connection contexts and ground-truth risk assessments, leading to improved accuracy in production.

Because the generative AI model is able to process high-dimensional semantic features encoded in natural language, the server achieves a technically improved classification performance compared to conventional rule-based or simple statistical anomaly detection systems. In particular, the server reduces false positives by distinguishing benign atypical behavior from truly malicious patterns, and improves detection of sophisticated threats that exhibit subtle contextual anomalies.

### 4. External Storage Device Access and Correlation

The server accesses external storage devices that contain fraud-related information and communication identifier information. The server uses encrypted communication protocols between the server and the external storage devices. The server periodically queries the external storage devices for updates and caches the retrieved data in local storage with summary indexes.

When evaluating a connection, the server searches for matches between the current connection information and entries in the fraud-related information and communication identifier information. For example, the server compares the source network address against a list of addresses associated with prior fraudulent activities. The server also compares device identifiers and other communication identifiers, if available.

The server then correlates the external comparison results with the evaluation information and numerical risk information from the generative AI model. The server may implement a weighted combination algorithm, in which the external fraud indication contributes a higher weight when recent evidence is strong, while the generative AI model's risk score influences decisions when the external evidence is weak or absent. The server uses a configurable table of thresholds and weights stored in the memory to compute a combined risk measure. By integrating generative AI-based evaluation with external threat intelligence in this structured way, the server achieves a more precise and robust risk calculation than systems that rely solely on either local behavior analysis or external lists. This leads to fewer unnecessary restrictions and improved protection against known and emerging threats.

### 5. Control of the Communication Control Device and Technical Effect

The server outputs control information to the communication control device in order to enforce restrictions on connections determined to have a possibility of a wrongful act that exceeds a predetermined criterion. The server sends control commands specifying operations such as temporarily blocking traffic from a particular network address, limiting specific protocols or ports, or placing the terminal into a quarantine network segment.

The communication control device applies these instructions at the packet processing level using hardware or software filtering mechanisms. Because the server computes risk assessments more accurately and quickly, the server can issue control commands in near real time, reducing the window during which malicious traffic could reach protected resources. At the same time, by avoiding unnecessary blocking due to improved precision, the server reduces the number of legitimate connections that are erroneously restricted. This leads to technical improvements in overall network throughput and resource utilization.

The server also reduces communication load by selectively applying deep inspection only to connections with elevated risk scores. For low-risk connections, the server allows more lightweight processing, thereby saving CPU cycles and memory bandwidth. This dynamic resource allocation, driven by the numerical risk information from the generative AI model, optimizes system performance and reduces latency for benign traffic.

### 6. User Interaction and Additional Prompt Generation

When the possibility of a wrongful act exceeds the predetermined criterion, the server presents inquiry information and explanation information on the user display device of the terminal. The server formats the explanation information using at least a part of the evaluation information from the generative AI model, so that the user can see why the connection was deemed risky. The server also includes clear questions about the purpose of the connection, the relationship to the terminal, and the necessity of the access.

The user reviews the displayed information on the terminal and inputs additional information. For example, the user may indicate that they are traveling to a new country for work or that they have just enrolled a new device. The terminal transmits this additional information to the server.

The server then generates an additional prompt sentence that combines the original connection context and the newly obtained user explanation. For example, the server may generate the following prompt sentence:

The user has provided additional information about the previous access.

### Previous Evaluation:

User ID: u12345
Source IP: 198.51.100.10 (Country X)
Access time: 02:05 local time
Initial risk assessment: high
   User explanation:
The user is on a business trip to Country X.
The access is needed to work on an urgent project.
The device is a newly issued corporate laptop.

### Question:

Given the above explanation, please re-evaluate the risk of this access.

Is the connection still suspicious, or is it now consistent with legitimate behavior? Provide a risk score between 0 and 1 and a brief explanation.

The server inputs this additional prompt sentence into the generative AI model and receives re-evaluation information. The server then updates the determination of the possibility of a wrongful act and adjusts the restriction state of the connection accordingly. This iterative loop between the server, the generative AI model, and the user enables a refined, context-aware control mechanism that goes beyond simple binary blocking logic.

### 7. Technical Improvements Over Conventional Computer Systems

The server improves computer technology in several ways. First, by using a generative AI model with a transformer-based architecture and prompt sentences encoding structured context, the server enables more accurate and nuanced classification of network connections than conventional rule engines or simple classifiers. The improved accuracy reduces the number of false positives and false negatives, directly improving the reliability of the network protection system and reducing unnecessary reprocessing and manual intervention. Second, the server employs specific data structures and indexing schemes for behavior information and history information that reduce the time needed to construct prompt sentences and evaluate connections. Indexes on user identifiers, device identifiers, and time ranges allow the server to assemble rich context in constant or logarithmic time relative to the number of stored records, thereby enhancing the efficiency of the behavior analysis pipeline. Third, the server uses a non-conventional control flow whereby numerical risk information from the generative AI model is combined with external fraud-related information in a weighted fashion to control the level of inspection and enforcement. This dynamic control flow leads to reduced CPU usage and memory access for low-risk connections and concentrates computational resources on high-risk connections, resulting in indirect technical benefits such as improved throughput and reduced latency.

Fourth, the server implements a structured user-feedback mechanism integrated with the generative AI model via additional prompt sentences. This mechanism allows the server to correct or refine its internal representation of user behavior in near real time, thereby improving model performance without retraining and providing an adaptive defense that is not merely a static automation of human review. The combination of automated evaluation, external data correlation, and structured human feedback creates a feedback loop that is executed by the server as a specific technical process.

Fifth, the server improves data management and auditability by storing history information that includes not only raw connection data but also prompt sentences, evaluation information, numerical risk information, correlation results, and user responses. This structured logging allows later analysis and optimization of model thresholds, weighting schemes, and policy settings. It also facilitates forensic investigations and continuous improvement of the system, which are technical contributions in the domain of security system design.

### 8. Alternative Embodiments and Variations

In another embodiment, the server uses a different type of generative AI model, such as a recurrent neural network or a hybrid architecture combining convolutional layers for encoding structured features and transformer layers for managing long-range dependencies in the prompt sentences. The training process may employ different loss functions or regularization techniques, such as dropout or weight decay, to prevent overfitting to specific attack patterns and to maintain generalization performance.

In another embodiment, the server divides the model into sub-models: a first model specialized in evaluating time-based anomalies, a second model specialized in evaluating geographic anomalies, and a third model specialized in evaluating device anomalies. The server constructs separate prompt sentences for each sub-model and combines their outputs according to a fusion algorithm. This modular approach allows fine-tuning of separate components and can yield further improvements in classification accuracy and computational efficiency.

In yet another embodiment, the server performs on-device pre-processing at the terminal, such as collecting local hardware identifiers or environmental measurements, and sends summarized features to the server. The server incorporates such device-side features into the prompt sentences, leading to better discrimination between compromised and uncompromised terminals.

The server may also vary the manner in which control information is applied. For example, the server may instruct the communication control device to redirect suspicious connections to a honeypot environment for further observation or to apply bandwidth limitations rather than complete blocking. These alternative enforcement strategies are all governed by the same risk assessment framework using generative AI model outputs, external fraud data, and user feedback.

By implementing these embodiments and variations, the server provides a concrete, technically grounded mechanism for enhancing network security using a generative AI model configured by prompt sentences, and directly controls real-world communication devices. This configuration goes beyond abstract data processing and yields measurable improvements in processing speed, detection accuracy, resource utilization, and system robustness.

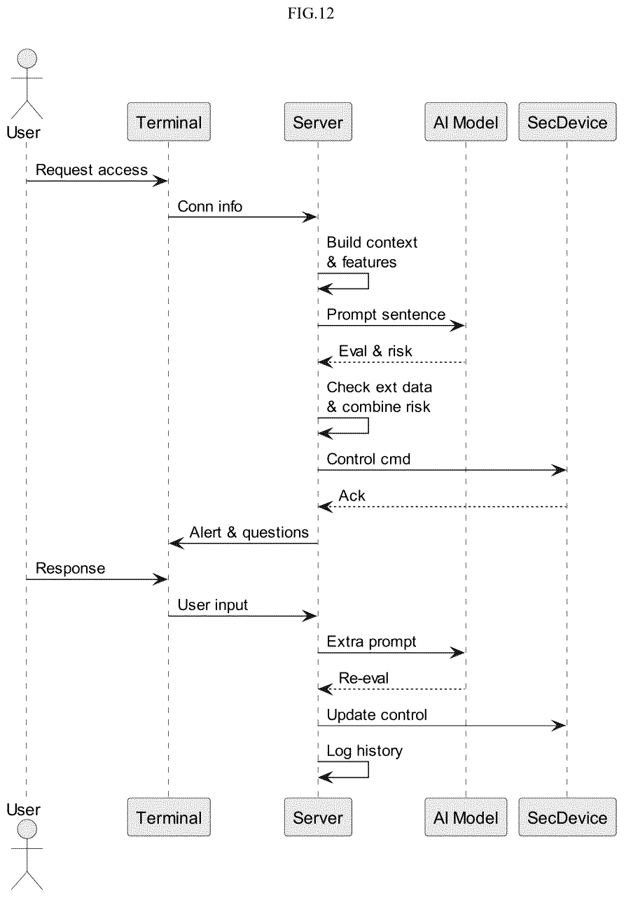

The following describes the processing flow using FIG. 12.

### Step 1:

Server receives a connection attempt from a terminal and acquires raw connection information.

Input: Network packets and session metadata sent from the terminal to a protected resource.

Output: A structured connection record stored in memory or a database.

Server captures packets through a network interface, parses protocol headers, and extracts fields such as source network address, destination network address, protocol type, port numbers, timestamps, and device identifiers if available. Server queries a location database using the source network address to obtain geographic location information and combines these fields into a connection record with a unique connection identifier. Server writes this connection record into a structured storage system for later processing.

### Step 2:

Server associates the connection with a user and retrieves related behavior history.

Input: The connection record from Step 1 and authentication or session information received from the terminal.

Output: An enriched context record that links the connection to a user and includes behavior history.

Server examines authentication data such as login credentials or tokens and maps the connection to a user identifier. Server queries a history database using the user identifier and the terminal identifier to retrieve past connection times, typical geographic regions, usual communication protocols, and known device identifiers. Server aggregates this information into a context record that includes both the current connection information and historical behavior attributes.

### Step 3:

Server computes derived behavioral features that quantify deviations from normal patterns.

Input: The enriched context record from Step 2.

Output: A feature set that numerically and symbolically expresses anomalies and normalities.

Server calculates measures such as the time difference between the current connection time and the typical login time range, the frequency of connections within a recent time window, whether the geographic location has been used before by the same user, and whether the device identifier matches a known device. Server transforms these measures into both numeric values (for example, deviation minutes, anomaly flags) and descriptive phrases indicating how the current behavior compares to stored patterns. Server appends this feature set to the context record.

### Step 4:

Server generates a prompt sentence for a generative AI model based on the context and features.

Input: The context record and the feature set from Step 3.

Output: A prompt sentence in natural language that encodes the connection, history, and derived features.

Server selects a prompt template appropriate for the type of connection and the initial anomaly indicators. Server fills template fields with user identifier, network address, device description, time, history summaries, and computed deviations, forming a coherent textual description. Server embeds specific questions at the end of the prompt, requesting evaluation of purpose, device trust level, conformity to normal behavior, and an overall risk score. Server produces a single text string that constitutes the prompt sentence.

### Step 5:

Server sends the prompt sentence to a generative AI model and obtains evaluation information and numerical risk information.

Input: The prompt sentence from Step 4.

Output: Evaluation information in natural language and a numerical risk measure for the connection.

Server transmits the prompt sentence to the generative AI model through an application programming interface using a communication protocol. Inside the generative AI model, an encoder converts the prompt into token embeddings, multiple transformer layers compute context-dependent representations, and an output layer produces text tokens representing classifications and explanations, as well as numeric tokens representing a risk value. Server receives the generated response, parses it into structured fields, and extracts elements such as the inferred purpose of the connection, a trust level category, indicators of whether time and location are normal, and a numerical risk score. Server attaches these outputs to the context record.

### Step 6:

Server accesses external storage devices to obtain fraud-related information for correlation.

Input: Identification information from the connection record (for example, network address, device identifier) and configuration specifying external data sources.

Output: External fraud indicators associated with the connection.

Server establishes encrypted communication sessions with external storage devices that maintain fraud-related data and communication identifier lists. Server sends queries containing the relevant identifiers for the current connection, receives responses indicating whether the identifiers appear in records of known or suspected wrongful acts, and may also obtain associated categories and timestamps. Server interprets the responses into standardized fields such as reputation level, threat category, and last seen time, and adds these to the context record.

### Step 7:

Server computes a combined risk assessment using AI outputs and external fraud indicators.

Input: Evaluation information and numerical risk information from Step 5, and external fraud indicators from Step 6.

Output: A combined risk value and a classification decision for the connection.

Server applies a combination algorithm that may assign weights to the numerical risk score from the generative AI model and to external reputation levels. Server calculates a combined risk value by performing arithmetic operations over these weighted components. Server compares the combined risk value and classification labels against predetermined criteria stored in configuration data to decide whether the connection is low risk, medium risk, or high risk. Server records the combined risk assessment and decision in the context record.

### Step 8:

Server determines an enforcement action and prepares control information for the communication control device.

Input: The classification decision and combined risk value from Step 7.

Output: A control instruction specifying how traffic from the terminal should be handled.

Server consults an enforcement policy table that maps risk levels to actions such as allow, temporarily restrict, or block. Server selects a specific action and generates control information that includes rule conditions (for example, matching network address or device identifier) and actions (for example, dropping packets, limiting protocols, or redirecting traffic). Server formats this control information in a way suitable for the communication control device and stores it for transmission.

### Step 9:

Server transmits control information to the communication control device to apply network enforcement.

Input: The control instruction from Step 8.

Output: Updated state of the communication control device resulting in changed network behavior for the connection.

Server sends commands encoding the control information to the communication control device via a management interface or protocol. The communication control device updates its internal rule tables or filter configurations, causing subsequent packets from the specified network address or terminal to be processed according to the new rules. Server confirms that the changes were applied, and updates the connection status in the context record to indicate whether it is allowed, temporarily restricted, or blocked.

### Step 10:

Server generates notification information and explanation information for display to the user.

Input: The context record including evaluation information, numerical risk information, external fraud indicators, and enforcement action.

Output: A human-readable alert and explanation package sent to the terminal.

Server constructs a message that summarizes the key elements of the risk assessment, including the reason for the classification, the numerical risk score, and any matches with external fraud data. Server formats explanation information using the natural language evaluation produced by the generative AI model and may add concise technical details such as the unusual time of access or the new device identifier. Server attaches instructions or options for the user to respond, such as permission, blocking, or providing additional details. Server transmits this notification and explanation package to the terminal.

### Step 11:

Terminal presents the notification and explanation to the user and collects user input.

Input: The alert and explanation package from Step 10.

Output: User responses including permission information, blocking information, or additional explanation.

Terminal receives the message, renders the content on a display device, and shows the risk level, reasons, and available actions. Terminal may display buttons or input fields for the user to select whether to allow or block the connection or to enter explanatory text about the circumstances of the access. User reads the information, decides on an appropriate response, and operates input devices such as a keyboard, pointing device, or touch interface to submit their choice and any additional explanation. Terminal packages this input into a structured response message and sends it to the server.

### Step 12:

Server processes user responses and, if additional information is provided, generates an additional prompt sentence.

Input: User responses received from the terminal, including permission decisions and optional explanatory text.

Output: An updated control decision and, when applicable, an additional prompt sentence for re-evaluation.

Server interprets the permission or blocking indication and, if the user provides additional explanation, extracts key phrases and details such as reasons for unusual location or new device use. Server stores this additional information in the context record. If the enforcement policy requires re-evaluation when new information is received, server integrates the additional explanation into a new prompt template. Server generates an additional prompt sentence describing the original risk assessment and the new user-supplied context, and prepares this text for submission to the generative AI model.

### Step 13:

Server sends the additional prompt sentence to the generative AI model and receives re-evaluation information.

Input: The additional prompt sentence generated in Step 12.

Output: Updated evaluation information and an updated numerical risk value.

Server transmits the additional prompt sentence to the generative AI model via the same interface used earlier. The generative AI model processes the augmented context, computing new internal representations and generating text outputs that reflect the revised understanding of the situation. Server parses the returned text to obtain updated assessments, including a new risk score and an explanation that references the user's additional information. Server writes these updated evaluation results back to the context record.

### Step 14:

Server recalculates the possibility of a wrongful act and updates the restriction state of the connection.

Input: Updated evaluation information and numerical risk value from Step 13, along with existing external fraud indicators.

Output: A revised enforcement decision and corresponding updated control information.

Server recomputes the combined risk measure, taking into account the new risk score and explanation while maintaining external fraud data. Server compares the new combined risk measure to the predetermined criteria and decides whether to maintain, relax, or strengthen the enforcement action. Server modifies or cancels previous control instructions accordingly, generating new control information if necessary. Server then sends any updated control instructions to the communication control device and records the final decision for the connection.

### Step 15:

Server records the entire processing history for later analysis and optimization.

Input: All intermediate and final data associated with the connection, including connection information, context, feature sets, prompt sentences, evaluation outputs, external fraud results, user responses, and control actions.

Output: A comprehensive history record stored in a persistent storage system.

Server compiles the various elements into a structured history record, assigning identifiers and timestamps for each state transition and decision. Server inserts this record into a history database or logging system with indexing by user, device, network address, and risk level. Server thereby creates a dataset suitable for future analysis, such as tuning thresholds, retraining generative AI models, or improving weighting schemes in the risk combination algorithm.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional fraud detection systems for electronic funds transfers are typically implemented as rule-based engines that analyze only structured transfer data such as destination account identifiers, transfer amounts, and static sender attributes. These systems often rely on simple pattern matching against fraud blacklists or threshold checks on transaction amounts. As a result, they are poorly suited to handle evolving fraud patterns, especially social-engineering type frauds in which an adversary manipulates a user's psychological state through urgent phone calls or messages. From a computing perspective, such systems underutilize available multimodal data generated at the user interface, including voice, image, and fine-grained operation logs, and therefore fail to exploit the full information content available to an information processing apparatus.

Furthermore, existing systems that incorporate machine learning or generative models typically use these models in isolation from other subsystems. For example, a natural language model may process only text fields entered by the user, while database matching and user interface control are handled by separate components without an integrated decision logic. This fragmented architecture leads to several technical problems:
(1) latency and inconsistency in risk evaluation due to repeated, redundant processing of similar data by different modules;
(2) difficulty in deterministically combining heterogeneous signals (language-based risk, database match status, user behavior) into a single, actionable control decision;
(3) inability to systematically log the internal reasoning (including prompts and model outputs) in a machine-readable form for later analysis and system improvement.

In addition, many deployed systems do not compute or utilize rich features derived from user interaction streams. For instance, raw audio captured at a terminal is often used only for human review or discarded after a simple transcription, and is not processed by the computing system to extract acoustic features indicative of stress or anxiety. Likewise, image frames from a camera and detailed operation logs (inter-key timing, correction counts, dwell times) are rarely fused algorithmically. This results in a computer system that treats high-dimensional interaction data as unstructured noise, limiting the achievable accuracy and robustness of automatic risk assessment.

From a user-interface control perspective, conventional systems generally implement static warning flows triggered by threshold conditions. They do not dynamically adjust the interface control (such as blocking execution, issuing additional warnings, or adaptively asking follow-up questions) based on a combined evaluation of a generative AI model's output, database matching results, and quantified emotional state. Consequently, these systems fail to provide a technically optimized control loop that closes the feedback between model inference, user responses, and system behavior.

There is therefore a need for an improved computer-implemented system that:
(1) acquires and processes multimodal input data (structured transfer data, audio, image, and operation logs) in a coordinated pipeline;
(2) generates structured prompt sentences for a generative AI model that integrate recognized speech, database-derived risk indicators, and inferred emotional information;
(3) deterministically fuses the output of the generative AI model with database matching results and emotion estimates to compute a comprehensive fraud risk level;
(4) controls the user interface at a terminal, including dynamic blocking and unblocking of transfer execution, according to the computed risk; and
(5) records, in a machine-readable, transaction-linked format, all intermediate and final inference results, prompts, and control actions for subsequent analysis and system refinement. Such a system would constitute an improvement in computer technology by providing a concrete architecture and processing pipeline that efficiently coordinates multiple specialized programs (speech recognition, feature extraction, database query, generative AI inference, and control logic) to achieve higher-precision, lower-latency, and more explainable fraud risk evaluation and control than is achievable with conventional siloed or rule-only systems.

The specific processing by the specific processing unit 290 of the data processing device 12 in Example 2 is realized by the following means.

The present invention provides a server comprising a processor and a memory storing instructions which, when executed by the processor, cause the server to acquire, from a terminal device, transfer-related numerical information and character information, and voice information, image information, and operation history information associated with a funds transfer transaction; perform speech recognition processing on the voice information to generate text information representing utterance content; generate a prompt sentence for a generative AI model based on the text information representing the utterance content and the transfer-related numerical information and character information; input the prompt sentence to the generative AI model and obtain response information including a fraud risk evaluation result and at least one additional question sentence. The processor is further configured to query, based on the transfer-related numerical information and character information and attribute information relating to a user, a first information storage apparatus in which fraud-related transaction information is stored and a second information storage apparatus in which a plurality of transaction histories are stored, and to generate matching result information indicating a fraud risk relating to the funds transfer transaction based on query results; to estimate an emotional state of the user based on at least part of the voice information, the image information, and the operation history information by executing an acoustic feature extraction program, an image feature extraction program, and an operation feature extraction program and to generate emotional information indicating the emotional state; to determine a comprehensive fraud risk level for the funds transfer transaction based on the fraud risk evaluation result obtained from the generative AI model, the matching result information, and the emotional information; to determine, in accordance with a determination result of the comprehensive fraud risk level, warning information to be displayed or output as sound by the terminal device and at least part of the at least one additional question sentence and to control continuation or temporary suspension of transfer operation at the terminal device; and to record, in an information storage apparatus, the fraud risk evaluation result, the matching result information, the emotional information, and control content by the processor in association with the funds transfer transaction. This enables an integrated, computer-implemented fraud risk assessment and control mechanism that leverages multimodal feature extraction, structured prompt generation for a generative AI model, deterministic fusion of heterogeneous risk indicators, and transaction-linked logging to improve the accuracy, responsiveness, and explainability of automated fraud detection in electronic funds transfer environments.

The term “system” refers to an information processing arrangement including at least one server, at least one terminal device, and one or more storage apparatuses that cooperate to execute the processing described in the claims.

The term “processor” refers to a hardware computing element, such as a central processing unit or other programmable logic device, configured to execute instructions to perform data acquisition, analysis, control, and storage operations described in the claims.

The term “terminal device” refers to an information processing apparatus used by a user to perform a funds transfer transaction, the apparatus including at least a user interface, a communication interface, an audio input device, optionally an image capturing device, and an operation input device.

The term “transfer-related numerical information” refers to numerical data associated with a funds transfer transaction, including at least a transfer amount and may further include other numeric identifiers used in financial processing.

The term “transfer-related character information” refers to string data associated with a funds transfer transaction, including at least destination account identifiers, recipient names, and financial institution identifiers.

The term “voice information” refers to digital audio data obtained from a user's spoken utterance via an audio input device of the terminal device and representing the acoustic waveform of the utterance.

The term “image information” refers to digital image data obtained by an image capturing device of the terminal device and including at least an image of a user's face or upper body captured during a funds transfer transaction.

The term “operation history information” refers to data representing a sequence of user interactions with a user interface of the terminal device, including event types, timestamps, screen identifiers, and key or button operations.

The term “speech recognition processing” refers to a computational procedure that converts voice information into text information representing the linguistic content of a user's spoken utterance.

The term “text information representing utterance content” refers to character data output by the speech recognition processing that expresses, in textual form, the semantic content of the user's spoken explanation.

The term “generative AI model” refers to a machine learning model, such as a large language model or other generative model, that receives a prompt sentence as input and outputs generated natural language or structured data including a fraud risk evaluation result and one or more question sentences.

The term “prompt sentence” refers to a textual input sequence provided to the generative AI model, the sequence including at least recognized utterance content, transfer-related information, and optionally emotional and database matching information, and specifying a desired fraud risk evaluation task.

The term “fraud risk evaluation result” refers to information output by the generative AI model representing an assessment of the likelihood that a funds transfer transaction is related to fraudulent activity, and may include a numerical score and explanatory text.

The term “additional question sentence” refers to a text string output by the generative AI model indicating a question intended to be presented to the user at the terminal device in order to further assess the legitimacy of a funds transfer transaction.

The term “information storage apparatus” refers to a data storage component, such as a database system or file storage system, configured to store information including fraud-related transaction information, transaction histories, and transaction logs.

The term “fraud-related transaction information” refers to stored data describing historical or known fraudulent activities, including information about accounts, contact identifiers, and transaction patterns associated with fraud.

The term “transaction histories” refers to stored data records describing past funds transfer transactions associated with one or more users, including at least transfer amounts, dates, counterparties, and transaction types.

The term “matching result information” refers to information generated by querying one or more information storage apparatuses using transfer-related information and user attribute information, the information indicating a fraud risk based on whether a current transaction correlates with stored fraud-related transaction information or deviates from historical transaction patterns.

The term “attribute information relating to a user” refers to data about a user performing a funds transfer transaction, including at least an identifier, an age group, and other characteristics derived from or associated with prior transactions.

The term “acoustic feature extraction program” refers to a software component executed by the processor to calculate numerical features from voice information, such as fundamental frequency, energy, speaking rate, and pause patterns.

The term “image feature extraction program” refers to a software component executed by the processor to calculate numerical or categorical features from image information, such as facial expression indicators and facial region descriptors.

The term “operation feature extraction program” refers to a software component executed by the processor to calculate numerical features from operation history information, such as key press intervals, correction counts, and dwell times on particular screens.

The term “emotional state” refers to an estimated psychological condition of a user, such as calmness, anxiety, nervousness, or confusion, inferred from analysis of voice information, image information, and operation history information.

The term “emotional information” refers to data representing the estimated emotional state, including at least an emotion category and may further include a confidence score or intensity value.

The term “comprehensive fraud risk level” refers to an overall assessment of fraud risk for a funds transfer transaction, generated by combining at least the fraud risk evaluation result from the generative AI model, the matching result information, and the emotional information.

The term “warning information” refers to information for prompting the attention of a user at the terminal device, including text data or audio messages instructing the user to review, reconsider, or suspend a funds transfer transaction.

The term “continuation or temporary suspension of transfer operation” refers to control states applied to a funds transfer user interface at the terminal device, including a state in which a user is allowed to execute a transfer and a state in which execution of the transfer is disabled or delayed.

The term “control content” refers to data indicating actions taken by the processor to manage the user interface and transaction flow at the terminal device, such as enabling or disabling buttons, presenting warnings, and determining whether to permit or block a transfer.

The term “answer information” refers to data representing a user's responses to one or more additional question sentences, including at least identifiers of the questions and corresponding user-selected answers.

The term “re-evaluate the comprehensive fraud risk level” refers to an operation in which the processor updates the comprehensive fraud risk level by integrating answer information with a previously computed fraud risk evaluation result, matching result information, and emotional information.

In one embodiment, a server, a terminal, and a user cooperate to implement the claimed system as an integrated computer-implemented fraud risk assessment and control platform.

### A. Overall Hardware and Software Configuration

Server operates as an information processing apparatus that includes at least one central processing unit, a main memory, a non-volatile storage device, and a network interface. Server executes an operating system, such as a general-purpose server operating system based on a UNIX-like kernel, and executes application programs written, for example, in a programming language such as Python, C++, or Java. Server optionally deploys a web application framework, such as a RESTful web framework, to expose application programming interfaces to terminal.

Terminal operates as an information processing apparatus installed at a financial institution facility or another user-accessible location. Terminal includes a touch-panel display, a card reader, an audio input device, an optional image capturing device, a speaker, and a network interface. Terminal executes an embedded operating system or a general-purpose operating system for client devices, and executes a client application that implements user interface rendering, local data buffering, and communication with server.

User interacts physically and visually with terminal by inserting a payment card into the card reader, touching the touch-panel, speaking into a microphone, and facing toward the image capturing device.

### B. Software Modules on Server

Server executes a plurality of software modules, each realized as a process, thread, or microservice.

### 1. Data Acquisition and Storage Module

Server includes a data acquisition and storage module implemented as a web application. This module defines endpoints for receiving transfer-related numerical and character information, voice information, image information, and operation history information from terminal. Server parses received multipart/form-data or structured message formats and stores binary files, such as audio waveforms and image frames, in a file storage area. Server stores structured data, such as transfer amount, destination identifiers, and operation log entries, in a relational database or key-value store with a transaction identifier as a primary key.

### 2. Speech Recognition Module

Server includes a speech recognition module that calls a speech recognition engine. The speech recognition engine can be implemented as an on-premise automatic speech recognition library or a cloud-based speech-to-text service. Server loads the raw audio waveform from storage, performs optional pre-processing such as noise reduction and normalization, and calls the engine with specified parameters including sampling rate, language code, and segmentation options. The engine outputs a sequence of tokens and associated confidence scores, and server converts this sequence into text information representing utterance content. Server optionally uses language models to restore punctuation and segment sentences and then saves the resulting text into the database linked to the transaction identifier.

### 3. Feature Extraction Modules

Server includes an acoustic feature extraction program, an image feature extraction program, and an operation feature extraction program.

Server, in the acoustic feature extraction program, computes low-level descriptors such as Mel-frequency cepstral coefficients, fundamental frequency contour, frame energy, zero-crossing rate, and voice activity flags by processing the digitized waveform in short overlapping frames. Server aggregates frame-level features into segment-level statistics including means, variances, maximums, minimums, and percentile values. These numerical descriptors form an acoustic feature vector for each spoken segment.

Server, in the image feature extraction program, loads one or more image frames containing the user's face, executes a face-detection subroutine implemented using an image processing library such as a computer vision framework, and crops detected face regions. Server resizes each region to a fixed resolution and normalizes pixel values. Server then feeds each processed face image into a trained facial expression recognition model, such as a convolutional neural network having layers organized in a stack of convolutional, pooling, and fully connected layers. The model outputs probabilities for predefined emotion categories, such as neutral, happiness, sadness, fear, and anxiety. Server aggregates probabilities over multiple frames to reduce noise and to obtain stable image-derived emotion estimates.

Server, in the operation feature extraction program, loads operation history information stored in the database. Each operation history entry includes at least an event type, a timestamp, a control identifier, and a screen identifier. Server computes numerical features such as inter-event time intervals, counts of correction operations, dwell times on confirm screens, and ratios of backspace operations to character inputs. Server aggregates these into feature vectors representing user behavior in the transaction session.

### 4. Emotion Estimation Module

Server implements an emotion estimation module that receives the acoustic feature vector, the image-derived emotion probabilities, and the operation feature vector. In one embodiment, server uses a multi-modal neural network composed of a first sub-network for acoustic features, a second sub-network for image-based probabilities, and a third sub-network for operation features. Each sub-network can be implemented as a feed-forward neural network with one or more hidden layers using nonlinear activation functions such as rectified linear units. The outputs of the sub-networks are concatenated and provided to a fusion layer followed by a softmax output layer producing probabilities over target emotional states.

Server trains this multi-modal network offline using supervised learning. Server uses a training dataset containing synchronized audio, image frames, operation history records, and ground-truth emotion labels obtained from human raters. Server minimizes a loss function, such as cross-entropy loss, by updating weights using optimization algorithms including stochastic gradient descent or adaptive moment estimation. Server optionally performs data augmentation techniques such as adding background noise to audio or applying small geometric transformations to images to increase model robustness. After training, server deploys the model in the emotion estimation module. When server receives features from a current transaction, server performs a forward pass through the network to obtain an emotion category and confidence score. Server stores this emotional information as a structured record including at least the emotion label and score.

### 5. Database Matching Module

Server implements a database matching module that queries one or more information storage apparatuses. Server connects to a storage system containing fraud-related transaction information, which includes flagged account identifiers, contact numbers, and pattern signatures of fraudulent behavior. Server also connects to a storage system that maintains transaction histories for users, including amounts, dates, recipients, and categories. Server, upon receiving a request with transfer-related information and user attributes, executes parameterized queries. Server checks whether the destination account or contact number appears in the fraud-related storage and retrieves associated risk markers. Server also retrieves the user's historical transactions and computes statistics such as typical amount ranges, most frequent recipients, and transfer frequencies during historical periods. Server compares the current transaction amount and destination against these distributions to derive deviation measures. Server then maps these findings to a matching result information structure containing a numerical risk score and flags representing conditions such as match with known fraudulent account or unusual high amount relative to user baseline.

### 6. Prompt Generation Module for Generative AI Model

Server includes a prompt generation module that constructs a prompt sentence for the generative AI model. This module assembles elements including the recognized text information, transfer-related numerical and character information, attribute information of the user such as age group, emotional information, and matching result information.

Server applies a predetermined template to form the prompt sentence. In one embodiment, server constructs a prompt sentence as follows:

“You are a fraud detection assistant for bank transfers using a generative AI model.

Evaluate the probability that this transfer is related to special fraud based on the following information.
1. User's statement about the purpose of the transfer: ‘I am sending money to my relative. I must pay urgently.’
2. Declared relationship to the recipient: ‘relative’
3. Transfer amount: 500,000 yen
4. User age group: 70s
5. Estimated emotional state from voice, face, and behavior: ‘strong anxiety’ (score 0.82)
6. Database matching result: ‘destination phone number appears in past fraud cases’ (database risk score: 70)

Output strictly in the following format:
fraud probability (an integer score from 0 to 100)
reasons why you judge the fraud probability to be high or low
three follow-up questions that the terminal should ask the user to verify the legitimacy of this transfer.”

Server stores the generated prompt sentence in persistent storage as part of the transaction record so that later analysis and debugging can be performed.

### 7. Generative AI Inference Module

Server includes a generative AI inference module that communicates with a generative AI model. The model can be implemented as a large language model based on a transformer architecture. This transformer architecture includes a stack of self-attention layers and feed-forward layers, trained on large corpora of text using unsupervised or self-supervised learning objectives, such as predicting masked tokens or next tokens.

Server sends the prompt sentence to the model via an application programming interface. Server configures inference parameters such as maximum output length, sampling temperature, and nucleus sampling thresholds to ensure reliable outputs. The model processes the prompt by computing contextual representations for each token, applying attention mechanisms to weigh token interactions, and generating output tokens representing the requested structure.

Server receives the generated text and parses it according to the format requested in the prompt. Server extracts the fraud probability score, reasons, and follow-up questions. Server converts the fraud probability to a numerical value, stores reason strings, and stores each additional question sentence in a list linked to the transaction identifier.

By employing a large language model trained on diverse sequences, server is able to obtain contextual evaluations that consider patterns of language associated with fraud, which are difficult to encode manually in simple rule sets. Additionally, by constraining the model output through carefully designed prompt sentences, server increases determinism and reduces ambiguity, thereby improving processing reliability at the computer level.

### 8. Risk Fusion and Control Decision Module

Server includes a risk fusion and control decision module. This module receives at least the numerical fraud score from the generative AI model, the matching result information including database-derived risk scores, and the emotional information. Server implements a deterministic algorithm, such as a weighted linear combination, a decision tree, or a trained classifier, to compute a comprehensive fraud risk level. For example, server can compute a composite score by assigning specified weights to the AI fraud score, database risk score, and emotion score, and then mapping the composite score to discrete categories such as low, medium, high, and very high.

Server associates each risk category with a predefined control policy. These policies specify whether terminal should allow immediate transfer execution, temporarily suspend execution, require additional user confirmation, or suggest consultation with an external institution. Server also associates each category with a warning message template to be displayed on terminal and a selection strategy for follow-up questions, such as selecting the most severe or most relevant questions from the list produced by the generative AI model.

Server generates control content including the risk category, the warning message text, the selected additional question sentences, and a flag indicating whether execution of the transfer should be blocked. Server then sends this control content to terminal as a structured message. Because server uses an explicit fusion algorithm rather than relying solely on a heuristic or on a single model output, the overall risk determination becomes reproducible and tunable. This structure allows system designers to adjust weights and thresholds to achieve a desired trade-off between false positives and false negatives while maintaining a clear technical implementation of the decision logic.

### 9. Logging and Reporting Module

Server includes a logging and reporting module that records, in an information storage apparatus, all relevant information for each transaction. Server writes, in association with the transaction identifier, the transfer-related numerical and character information, the recognized speech text, the prompt sentence provided to the generative AI model, the model's responses, the emotional information, the matching result information, the computed comprehensive fraud risk levels over time, the warning messages and additional questions sent to terminal, the control decisions (such as blocking or unblocking), and any answers received from user. Server can further derive summarized records for high-risk transactions and provide batched exports to external monitoring or enforcement systems. This structured and transaction-linked logging enables offline analysis, model retraining, threshold tuning, and investigation of system behavior, thereby improving the system over time.

### C. Software Modules on Terminal

Terminal executes a client application implementing user interface logic, sensor control, and server communication.

Terminal presents input screens using a graphical user interface toolkit. Terminal acquires transfer-related numerical and character information from user, records event timestamps and control identifiers, stores these as structured operation history information, and temporarily buffers all collected data before sending it to server.

Terminal acquires voice information using the audio input device and an audio driver.

Terminal buffers raw samples, stores them in an audio file, and attaches metadata. Terminal acquires image information using an image capturing device and a video capture library.

Terminal optionally pre-processes image frames using a computer vision library to detect and crop face regions before sending them to server, thereby reducing bandwidth and focusing the information on relevant regions.

Terminal receives control content from server and updates the user interface accordingly.

Terminal displays warning information conspicuously, optionally outputs it as synthesized speech through the speaker, temporarily disables a transfer execution button when instructed, and displays additional question sentences with answer choices. When user selects answers, terminal logs these selections and sends them back to server.

### D. Technical Effects and Improvement of Computer Technology

Server, by combining specialized feature extraction programs, a multi-modal emotion estimation network, a database matching module, a prompt generation module, and a generative AI inference module, implements a tightly coordinated data flow that differs substantially from simple automation of human fraud assessment. The system uses structured representations and explicit numerical features to capture nuances of user emotion and behavior, which humans can observe but do not quantify consistently. Because these features are fed into trained models and deterministic fusion algorithms, computer processing can detect subtle correlations among multimodal signals that are not apparent in conventional rule-based systems.

Server achieves improved processing speed by running feature extraction and database queries in parallel threads and by minimizing redundant data retrieval through the use of transaction identifiers and cached intermediate results. Server improves detection accuracy by using a trained multi-modal emotion network that reduces false negatives when fraudsters exert psychological pressure, and by using a generative AI model that can interpret the semantics of the user's utterance in context. Server enhances data management by storing all intermediate computations, including prompt sentences and model outputs, in structured, queryable formats. This consistent logging allows efficient offline analysis, targeted retraining, and regression testing of updated models.

Server's use of a large language model does not merely replace human reasoning but changes the computational procedure; server converts heterogeneous inputs into a single prompt sentence that encodes both factual and contextual attributes in a format that the transformer architecture can process efficiently. The attention mechanisms in the transformer reweight tokens based on contextual importance, leading to more discriminative embeddings and improved pattern recognition. By constraining outputs through prompt design, server uses non-conventional, model-specific control strategies that differ from manual rule-writing, thereby improving consistency and reducing human error in fraud evaluation.

In alternative embodiments, server can substitute or augment the large language model with other generative models, such as encoder-decoder architectures, while maintaining the same functional pipeline of prompt generation and structured output parsing. Server can also vary the emotion estimation architecture, for example by employing recurrent neural networks for time-series analysis of acoustic and operation features, or by applying graph neural networks to model dependencies between successive user actions. These variations still fall within the scope of the claimed invention as long as server executes the same overall functional steps of multimodal feature extraction, emotion estimation, prompt-based generative inference, fusion, control, and logging.

By directly controlling hardware components at terminal, such as enabling or disabling buttons and producing audio warnings in real time based on the computed risk, the system exhibits a concrete application in the physical world. The processing at server is not isolated reasoning; instead, it is tightly coupled to real-time control decisions that change the state of terminal and alter the flow of funds transfer operations, thereby providing a tangible technical effect in a financial transaction environment.

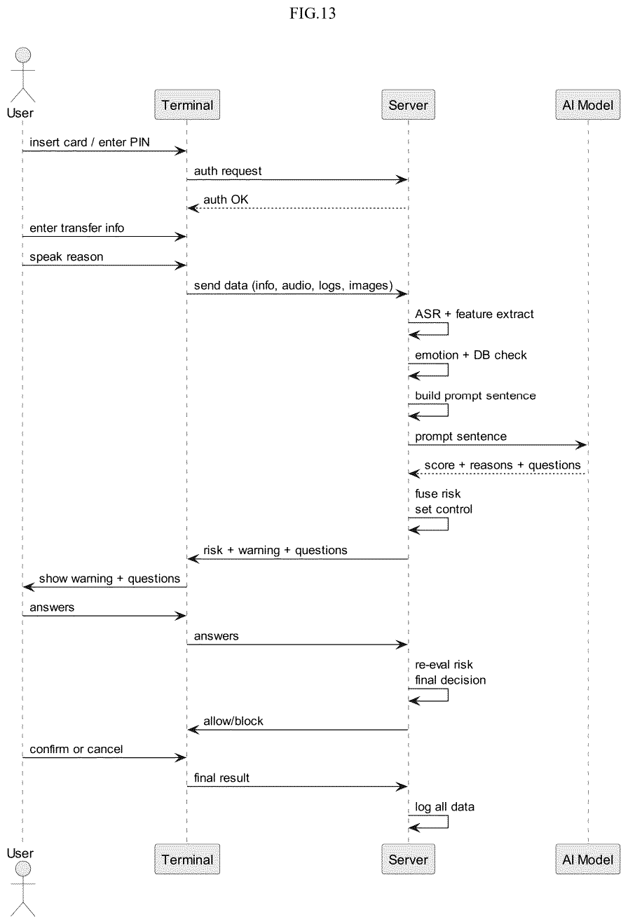

The following describes the processing flow using FIG. 13.

### Step 1:

User inserts a payment card into the terminal and authenticates.

Input: physical payment card, user PIN.

Output: authenticated user identifier and session identifier stored in terminal.

Terminal reads card data through a card-reader driver, decodes an account identifier and card identifier, and displays a PIN entry screen. User touches the numeric keypad on the touch panel to input the PIN. Terminal collects each key press as an event with a timestamp and assembles the PIN string. Terminal sends the card identifier and PIN to server or to an internal authentication module. Server or the module compares the PIN against stored authentication data, returns an authentication result, and terminal stores the authenticated user identifier and a newly generated session identifier in memory.

### Step 2:

User inputs transfer-related numerical and character information.

Input: authenticated session identifier, user touch inputs for destination account, recipient name, financial institution identifiers, and transfer amount.

Output: structured transfer information object and initial operation history records in terminal.

Terminal displays input fields for destination account, recipient name, bank name, branch name, and amount. User touches the touch panel to enter characters and numbers. Terminal records for each action the field identifier, the entered character, the event type (input, delete, confirm), and a timestamp. Terminal aggregates these events into an internal transfer information object having fields such as destination_account, destination_name, bank_code, branch_code, and amount, and simultaneously appends each event as an entry in an operation history list linked to the session identifier.

### Step 3:

User provides a spoken explanation of the transfer.

Input: user voice spoken into the microphone during the active session.

Output: digitized audio file and metadata stored in terminal.

Terminal presents an instruction such as “Please explain the purpose of this transfer using your voice” and displays a start/stop recording button. User presses the start button and speaks, for example, “I am sending money to my relative. I must pay urgently.” Terminal activates the audio input device via the audio driver, samples the analog audio signal at a fixed sampling rate, buffers raw audio frames in memory, and on pressing the stop button, writes the buffered audio into a file in a waveform format. Terminal also records metadata such as duration and sampling rate, and links the audio file path and metadata to the transfer information object.

### Step 4:

Terminal captures image information and detailed operation history.

Input: camera frames captured during the session and user interface events.

Output: stored face image samples and enriched operation history records.

Terminal periodically requests frames from the image capturing device at a predefined interval. Terminal executes a face-detection routine using an image processing library on each frame. When a face region is detected, terminal crops the region, resizes it to a standard resolution, compresses it into an image format, and appends the resulting bytes and timestamps to a list of face image samples. At the same time, terminal continues collecting operation history by logging button presses, field focus changes, screen transitions, and confirmation actions with timestamps and screen identifiers. Terminal stores these face images and extended operation history as part of the session data.

### Step 5:

Terminal transmits collected data to server.

Input: transfer information object, audio file, face image samples, and operation history.

Output: network request message to server containing all session data.

Terminal serializes the structured transfer information and operation history into a structured format, attaches the audio file and image files as binary parts, and forms a network request such as an HTTPS POST to a server endpoint. Terminal includes the session identifier and user identifier as headers or parameters. Terminal sends the request over the network interface and enters a wait state for server responses, ensuring that no final execution of the transfer is allowed until a control message is received.

### Step 6:

Server receives and stores session data.

Input: network request from terminal containing transfer information, audio file, image files, and operation history.

Output: persistent transaction record with file paths and structured fields in server storage.

Server, through a web application framework, parses the incoming request. Server writes the audio file and image files to a non-volatile storage path, stores transfer-related numerical and character information and operation history rows in a database, and generates a transaction identifier. Server stores the mapping from the session identifier and user identifier to the transaction identifier, and references file system paths where binary data resides. This processing converts the network-level request into structured and indexed records ready for later computation.

### Step 7:

Server performs speech recognition to obtain utterance text.

Input: audio file and transaction identifier.

Output: recognized utterance text stored in association with the transaction.

Server loads the audio file from storage and sends it to a speech recognition engine with parameters such as sampling rate and language code. The engine segments the waveform into frames, computes acoustic models, and emits a sequence of tokens with probabilities. Server converts this sequence into a text string, optionally applies normalization such as trimming silence markers and removing spurious characters, and stores the result as utterance_text in the transaction record. This processing transforms raw acoustic data into textual content that can be used in prompt sentence generation.

### Step 8:

Server computes acoustic, image, and operation features.

Input: stored audio file, face image samples, and operation history.

Output: acoustic feature vector, image-based emotion features, and operation feature vector.

Server applies an acoustic feature extraction program to the audio file. Server splits the waveform into overlapping frames, computes per-frame Mel-frequency cepstral coefficients, fundamental frequency, energy, and other descriptors, and then aggregates frame-level statistics into an acoustic feature vector. Server processes each face image through an image feature extraction program, cropping and normalizing the face and passing it into a trained convolutional neural network that outputs probabilities for emotion categories. Server aggregates these probabilities across images to produce a vector of image-based emotion features. Server feeds operation history entries into an operation feature extraction program, which computes inter-event time statistics, counts of corrections, and dwell times, then compiles these into an operation feature vector. These computations convert heterogeneous raw inputs into numerical representations suitable for model input.

### Step 9:

Server estimates user emotional state.

Input: acoustic feature vector, image-based emotion features, and operation feature vector.

Output: emotional information including an emotion label and confidence score.

Server inputs the acoustic feature vector, the image-based emotion feature vector, and the operation feature vector to a multi-modal neural network. The network computes activations through separate sub-networks for each modality and then through a fusion layer, generating probabilities over emotional states. Server selects the emotion state with highest probability, such as “strong anxiety,” and records a numerical confidence score. Server stores this emotional information in the transaction record. This data processing links measurable patterns in voice, appearance, and interaction behavior to a quantifiable emotional label.

### Step 10:

Server performs database matching for fraud-related information.

Input: transfer-related numerical and character information and user attribute information.

Output: matching result information with database risk score and flags.

Server constructs queries using the destination account identifier, contact number, and user identifier. Server sends queries to a fraud-related transaction information storage to check whether the account or contact number appears in a list of known fraudulent entries, and to a transaction history storage to retrieve the user's historical transfers. Server computes deviation metrics like “first time to this recipient” and “amount multiple of typical past amounts” and maps them to a database risk score. Server generates matching result information containing this risk score and flags such as match_with_known fraud or unusual_amount and stores it with the transaction. This processing transforms static database contents and current transaction parameters into a normalized risk representation.

### Step 11:

Server generates a prompt sentence for the generative AI model.

Input: recognized utterance text, transfer-related information, user attributes, emotional information, and matching result information.

Output: prompt sentence text prepared for generative AI model input.

Server retrieves the utterance_text, transfer amount, destination information, user age group, emotional label and score, and database risk summary from the transaction record. Server fills a template with these values to create a coherent prompt sentence. For example, server generates:

“You are a fraud detection assistant for bank transfers using a generative AI model.

Evaluate the probability that this transfer is related to special fraud based on the following information.
1. User's statement about the purpose of the transfer: ‘I am sending money to my relative. I must pay urgently.’
2. Declared relationship to the recipient: ‘relative’
3. Transfer amount: 500,000 yen
4. User age group: 70s
5. Estimated emotional state from voice, face, and behavior: ‘strong anxiety’ (score 0.82)
6. Database matching result: ‘destination phone number appears in past fraud cases’ (database risk score: 70)

Output strictly in the following format:
fraud probability (an integer score from 0 to 100)
reasons why you judge the fraud probability to be high or low
three follow-up questions that the terminal should ask the user to verify the legitimacy of this transfer.”

Server stores this prompt sentence in the database and passes it as the input sequence for the generative AI model. This step converts multiple structured internal fields into a single text input tailored to the model's processing characteristics.

### Step 12:

Server obtains a fraud risk evaluation result and follow-up questions from the generative AI model.

Input: prompt sentence.

Output: fraud risk evaluation result including a numerical fraud score, reasons, and additional question sentences.

Server calls the generative AI model's inference interface, providing the prompt sentence and inference parameters. The model processes the tokens, computes contextual representations in its internal layers, and generates output tokens that form a reply. Server receives the reply text and parses it according to the requested format. Server extracts the integer fraud probability, the list of textual reasons explaining the assessment, and the list of follow-up question sentences. Server stores these elements as the fraud risk evaluation result in the transaction record. This operation transforms the prompt sentence representing the aggregated transaction context into a structured evaluation output.

### Step 13:

Server fuses risk indicators and determines a comprehensive fraud risk level.

Input: fraud risk evaluation result, matching result information, and emotional information.

Output: comprehensive fraud risk level and associated control policy parameters.

Server reads the fraud score from the generative AI model, the database risk score and flags, and the emotional score and label. Server applies a fusion algorithm that computes a composite risk metric, for example by weighting the model score, database score, and emotion score. Server then compares this composite metric and certain flags against thresholds to assign a risk level category such as low, medium, high, or very high. Server maps the risk category to a control policy, specifying whether to block execution, which warning message to present, and how many follow-up questions to show. Server stores the comprehensive risk level and control policy in the transaction record. This computation unifies heterogeneous risk signals into a single actionable state that can drive terminal behavior.

### Step 14:

Server generates and sends control content to terminal.

Input: comprehensive fraud risk level, fraud risk evaluation result, and control policy.

Output: control message transmitted to terminal specifying warning content and interface control flags.

Server selects or composes a warning message based on the risk level, such as “This transfer is very likely to be special fraud. Stop the transaction immediately and consult your family or the police.” Server selects a subset of additional question sentences from the list generated by the generative AI model, according to a selection rule. Server sets a control flag such as block_execution to true for high or very high risk. Server encodes the risk level, warning message text, selected question sentences, and control flags into a structured response and sends it to terminal over the network. This processing converts internal risk assessments into directly executable terminal interface instructions.

### Step 15:

Terminal displays warning information and presents follow-up questions.

Input: control message from server.

Output: updated user interface state and user response inputs.

Terminal receives the control message, parses its fields, and updates the screen. Terminal overlays the warning message on the current transfer screen, optionally triggers text-to-speech output through the speaker, and disables or greys out the transfer execution button if instructed. Terminal displays each additional question sentence with selectable answer controls such as “Yes” and “No” buttons. User reads the messages and touches the appropriate answer buttons. Terminal logs each answer as part of operation history and assembles an answer data object containing question identifiers and selected answers. This processing changes the physical state of terminal's user interface based on server's computed control content and collects explicit user feedback.

### Step 16:

Terminal sends user answer information to server.

Input: answer data object containing user-selected responses.

Output: network request message to server with answer information.

Terminal serializes the answer data object along with the session and transaction identifiers into a structured format and sends it via a network request to a server endpoint dedicated to follow-up responses. Terminal then waits for updated control content, maintaining the existing restrictions on transfer execution until server provides a new decision. This operation forwards user feedback from the human interaction back into the server's computational loop.

### Step 17:

Server re-evaluates the comprehensive fraud risk level using answer information.

Input: previous comprehensive risk level, fraud risk evaluation result, matching result information, emotional information, and user answer information.

Output: updated comprehensive fraud risk level and final control decision.

Server retrieves the existing transaction record and reads all prior risk data and the new answer information. Server applies rules such as increasing the composite risk metric if the user answered “Yes” to questions indicating secrecy pressures, and possibly decreasing it if answers indicate normal circumstances. Server recomputes the composite metric and updates the risk category if necessary. Server sets a final decision flag such as allow_transfer or enforce_cancellation and generates an updated control policy including final warning messages. Server stores this updated risk level and decision in the transaction record and sends the updated control content to terminal. This recalculation integrates dynamic user responses into the risk assessment, allowing the system to adapt the control outcome.

### Step 18:

Terminal applies the final control decision to the transfer operation.

Input: updated control content including final risk level and decision flag.

Output: final state of the transfer operation (executed or cancelled) and final user interface display.

Terminal receives the final control content and adjusts its user interface accordingly. If the decision requires continued blocking, terminal keeps the execution button disabled and displays a strong recommendation to cancel the transfer. If the decision allows execution, terminal re-enables the execution button and displays a final confirmation message to user. User then either cancels the transaction or confirms execution by touching the appropriate button. Terminal, in the execution case, invokes communication with backend financial systems to initiate the actual funds transfer and then displays the transfer result. This step translates the server's computed decision into a concrete change in transaction outcome in the real-world system.

### Step 19:

Server records full transaction history and generates reporting data.

Input: all transaction-related data including initial inputs, intermediate computations, model interactions, user responses, and final outcome.

Output: comprehensive log record and optional summarized report for high-risk cases.

Server consolidates all data associated with the transaction identifier, including transfer-related information, utterance_text, feature vectors or derived metrics, emotional information, matching result information, prompt sentences, generative AI outputs, comprehensive risk levels over time, control messages, user answer information, and the final execution or cancellation result. Server writes this consolidated record to a log storage system. For transactions with high or very high risk level, server also constructs a summarized report containing key data fields and flags it for export to monitoring entities. This final processing step ensures that every computational and control decision is traceable and that data is available for retraining, tuning, and auditing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional network security systems typically rely on rule-based engines and static feature sets, such as IP address ranges, port numbers, protocol types, and simple signature patterns, to detect unauthorized access and fraud. These systems are configured to apply fixed heuristics or static machine-learning classifiers to network traffic and user inputs. As a result, they have difficulty accurately detecting subtle, context-dependent attacks, such as social-engineering attacks and emotionally manipulative fraud, that exploit human cognitive and emotional vulnerabilities rather than purely technical weaknesses.

In particular, existing systems usually treat technical access indicators (for example, connection time, geographic origin, protocol, and device fingerprint) independently from human factors. User messages and administrator behavior are either ignored or reduced to coarse indicators such as keyword lists or basic sentiment scores. Network administrators are then presented with large volumes of alerts in uniform user interfaces, regardless of their current stress level or cognitive load. This technical separation causes several concrete problems in computer operation.

First, because conventional systems do not integrate a generative AI model that can interpret access context and emotional content in natural language, they fail to leverage rich, high-dimensional patterns present in user messages and historical access behaviors. This leads to low recall for sophisticated fraud scenarios in which attackers carefully mimic normal workflows while embedding subtle urgency, fear, or authority cues in messages. From a computer-technology standpoint, the risk-evaluation pipeline is rigid and does not adapt its internal decision logic or user interaction model to contextual information, resulting in suboptimal utilization of processing resources and available data.

Second, conventional systems do not coordinate technical risk evaluation with estimation of the administrator's emotional state. The user interface is typically generated by a fixed template that exposes the same level of detail and the same set of control options regardless of whether the administrator is calm or under severe stress. In high-load incident situations, administrators frequently experience stress, fatigue, or cognitive overload, which increases the probability of erroneous approvals or blocks. However, prior art architectures do not provide any mechanism in the processor or software stack to dynamically reconfigure information density, control granularity, or default actions in response to measured emotional state. As a result, the human-computer interaction path remains static and inefficient, even when system telemetry indicates conditions that increase human error rates.

Third, existing access-control engines typically do not employ a generative AI model via prompt sentences as an integrated decision component. While some systems may use pre-trained classifiers or narrow AI components, they do not use a general-purpose generative AI model to synthesize technical indicators, historical unauthorized-access information, and emotional feature vectors into coherent, human-readable control-policy proposals. Consequently, the security processor cannot automatically generate nuanced policy recommendations that are adaptively aligned with both the assessed network risk and the administrator's cognitive condition. This leads to redundant manual work, inconsistent decisions, and inefficient use of computing and network resources.

Fourth, conventional logging and analytics components record packet-level and rule-level events but rarely capture the prompt sentences sent to generative models, the full textual outputs of such models, or the measured emotional indices of users and administrators as first-class incident attributes. This limits the system's capability to generate meaningful statistical correlations between emotional state, AI evaluations, and ultimate access decisions. Without this integrated data model, it is difficult to computationally analyze how different UI strategies, AI risk assessments, and administrator states affect error rates and incident outcomes, and thus difficult to iteratively improve the underlying computer system design.

Accordingly, there is a need for a computer-implemented network security system that improves core computer-technology functions-namely, risk-evaluation processing, policy-decision computation, user-interface generation, and incident logging-by: (i) integrating access information, unauthorized-access history, and emotional patterns via a generative AI model using structured prompt sentences; (ii) computing a unified risk level based on both technical and emotional indicators; (iii) dynamically adapting the user interface and control policy according to an administrator's emotional state; and (iv) recording AI prompts, AI outputs, and emotional indices as structured incident records for subsequent machine-based statistical analysis. Such a system would reduce misjudgments, increase detection accuracy for social-engineering attacks, and more efficiently utilize processing and network resources in the security pipeline.

The specific processing by the specific processing unit 290 of the data processing device 12 in Application Example 2 is realized by the following means.

The present invention provides a server comprising a processor configured to acquire access information from communication information passing through a communication path, generate a prompt sentence in a natural language including the access information and usage history information, input the prompt sentence to a generative AI model, execute natural language processing by the generative AI model, and obtain an evaluation result regarding a purpose of access and a reliability of an access source apparatus; compare the access information with unauthorized access information storage that stores unauthorized access information and emotion pattern storage that stores fraudulent emotional expression patterns, and obtain a comparison result based on presence or absence of a match or similarity with the unauthorized access information and the fraudulent emotional expression patterns; perform emotion estimation processing on a user message included in the access information or on voice input or text input from an administrator, and calculate an emotion index indicating emotional states of a user and the administrator; integrate the evaluation result of the generative AI model, the comparison result, and the emotion index, calculate a risk level of the access, determine an access control policy according to the risk level, and generate control information that dynamically changes information presentation content and information presentation format according to an emotional state of the administrator; control a communication control apparatus based on the access control policy so as to permit, restrict, or block the access; present warning information, recommended operation procedures, and an operation input interface to an administrator display apparatus based on the control information, and acquire, via the operation input interface, operation input from the administrator regarding permission or blocking; and store the access information, the prompt sentence, output of the generative AI model, the emotion index, the access control policy, and the operation input as an incident record, and generate statistical information based on the incident record. This enables the computer system to computationally fuse technical network indicators and emotional-state indicators within a unified risk-evaluation pipeline, to employ a generative AI model via structured prompt sentences for synthesizing detailed policy proposals, to automatically adapt user-interface complexity and control options to the administrator's current emotional state in order to reduce human error, and to persist fine-grained AI and emotion metadata as structured incident records that support subsequent machine-based analysis and iterative optimization of security control logic and interface behavior.

The term “access information” refers to information indicating characteristics of a communication access, including at least one of a network address, a port number, a protocol type, a timestamp, a device identifier, a geographic location, an application header, and an application payload segment associated with the communication.

The term “communication path” refers to a logical or physical path through which communication information is transmitted between computing apparatuses, including at least one of a wired network link, a wireless network link, a virtual private network, and an overlay network.

The term “communication information” refers to data units transmitted over a communication path, including at least one of packets, frames, segments, messages, and higher-layer protocol data exchanged between computing apparatuses.

The term “usage history information” refers to information indicating past behavior of an access source apparatus or a user, including at least one of historical access times, historical network locations, historical protocol usages, historical device identifiers, and previous authorization results.

The term “prompt sentence” refers to a text sequence expressed in a natural language and provided as an input to a generative AI model, the text sequence including at least the access information and the usage history information and optionally including other risk-related indices.

The term “generative AI model” refers to a computational model that receives a natural-language input including a prompt sentence and generates a natural-language output based on statistical learning or machine learning, the computational model including, for example, a large language model.

The term “natural language processing” refers to processing performed by a computational model to analyze or generate text expressed in a human language, including at least one of tokenization, embedding, language modeling, text generation, and text classification.

The term “evaluation result” refers to information output from the generative AI model indicating an assessment of at least one of a purpose of an access and a reliability of an access source apparatus, and optionally including a risk level or explanatory text.

The term “access source apparatus” refers to a computing apparatus that originates or attempts to originate the access to a protected computing resource or network resource.

The term “unauthorized access information storage” refers to a storage structure, such as a database or index, that stores information related to past unauthorized accesses, including at least one of network addresses, device identifiers, user agents, domain names, and associated incident metadata.

The term “emotion pattern storage” refers to a storage structure that stores patterns of fraudulent emotional expressions, including at least one of emotional feature vectors, phrase patterns, and labels representing typical emotional characteristics of fraudulent communications.

The term “fraudulent emotional expression pattern” refers to an expression pattern that appears in communications associated with fraud or social engineering, including at least one of urgency-inducing, fear-inducing, threatening, or confidential-information-requesting expressions.

The term “comparison result” refers to information indicating a result of comparing the access information with contents of the unauthorized access information storage and the emotion pattern storage, including at least one of a match flag, a similarity score, and an identification of a matched pattern.

The term “user message” refers to text data or message content transmitted by an access source apparatus or a user associated with the access, including at least one of email text, chat text, form input text, and application-layer message text.

The term “administrator” refers to a human operator who monitors, configures, or controls a network or system using an administrator display apparatus, and who may issue permission or blocking instructions regarding accesses.

The term “emotion estimation processing” refers to processing that estimates an emotional state of a user or an administrator based on at least one of voice data and text data, using computational techniques such as feature extraction and emotion classification.

The term “emotion index” refers to a value or a set of values indicating an estimated emotional state of a user or an administrator, including at least one of a stress level score, an emotion label, and a confidence value.

The term “risk level” refers to a quantitative or qualitative indicator representing a degree of risk that an access is unauthorized or fraudulent, the indicator being derived from at least one of the evaluation result, the comparison result, and the emotion index.

The term “access control policy” refers to a set of rules or instructions defining how to handle a particular access or class of accesses, including at least one of permitting, restricting, blocking, and requiring additional authentication.

The term “control information” refers to data that specifies how information presentation content and information presentation format are to be changed according to the emotional state of the administrator, and how an access control policy is to be applied by a communication control apparatus and an administrator display apparatus.

The term “communication control apparatus” refers to a computing apparatus or functional component that enforces communication control on network traffic according to the access control policy, including at least one of a firewall, a router, a switch, a gateway, and a software-based filtering module.

The term “administrator display apparatus” refers to a computing apparatus operated by the administrator and configured to present information regarding access risks and control options, including at least one of a workstation, a portable computing device, and a terminal executing a user interface program.

The term “warning information” refers to information presented to the administrator that indicates at least one of a high risk level, a suspected unauthorized access, and a suspected fraudulent emotional pattern in an access.

The term “recommended operation procedures” refers to instructions or guidance presented to the administrator suggesting one or more operations to be performed regarding the access, including at least one of temporarily blocking, permanently blocking, allowing, and performing additional verification.

The term “operation input interface” refers to a user interface component that enables the administrator to input an operation regarding permission or blocking of an access, including at least one of a graphical button, a menu, and a form field.

The term “operation input” refers to data representing the administrator's selection or command entered via the operation input interface, including at least one of a permission instruction, a restriction instruction, and a blocking instruction.

The term “incident record” refers to a structured data record that aggregates information related to a particular access or security event, including at least the access information, the prompt sentence, the output of the generative AI model, the emotion index, the access control policy, and the operation input.

The term “statistical information” refers to aggregated information derived from a plurality of incident records, including at least one of counts, distributions, correlation values, and trend metrics relating to risk levels, emotional states, and control decisions.

In an embodiment, a system includes a server, one or more terminals, and one or more users. Server executes a network security application on a general-purpose computing platform that includes at least one multi-core CPU, a main memory, a non-volatile storage device, and a network interface. Server optionally includes a graphics processing unit (GPU) for accelerating neural network inference. Server runs a server-class operating system and middleware including an application server, a scripting runtime such as a general-purpose scripting language interpreter, a deep learning framework such as a tensor-based neural network library, a natural language processing library such as a transformer-based language-model library, an audio processing library such as a time-frequency feature-extraction library, a packet processing library such as a low-level packet capture library, an IP geolocation database such as a structured IP-location mapping database, and a relational database management system such as a SQL-based database engine.

Terminal operates as an administrator-facing or user-facing client device. Terminal includes a display, an input device such as a keyboard and pointing device, and an audio input/output subsystem including a microphone and a speaker. Terminal runs a client operating system and a web browser or a dedicated client application that communicates with Server over a secure network protocol such as HTTPS or a real-time transport protocol. User operates Terminal to review alerts, receive recommendations, and input decisions regarding access permissions. Server stores program instructions in the non-volatile storage device. These instructions, when executed by the CPU (and optionally by the GPU), configure Server to carry out the functions defined in the claims. Server structures internal data using explicit data models, including an access information record, an incident record, and multiple auxiliary tables for unauthorized access information, emotion patterns, and configuration parameters.

Server uses the packet processing library and the network interface to receive communication information. Server parses raw packets into protocol-layer structures. Server constructs an access information record as a structured object comprising, for example, source IP address, destination IP address, source port, destination port, protocol type, timestamp, source device identifier (such as a MAC address), inferred geographic region, user-agent string, application-layer header fields, and an optional segment of message text. Server stores each access information record into the database with a unique access identifier.

Server uses the IP geolocation database to convert the source IP address into geographic information, using table lookups that map IP ranges to country codes and city identifiers. Server retrieves historical usage history information for the same source apparatus or associated account. Server represents usage history information as aggregated metrics, such as typical time-of-day distributions, country distributions, and protocol usage frequencies, stored in normalized tables keyed by a source identifier.

Server prepares a prompt sentence in a natural language by combining values from the access information record and the usage history information with a configurable template. Server retrieves a template string from a configuration repository. The template contains placeholders corresponding to access features and historical features. Server performs deterministic replacement of the placeholders with current values to construct the prompt sentence.

For example, Server constructs a prompt sentence such as:

“You are a network security expert.

Evaluate the risk of unauthorized access for the following connection.

[Access Information]
Source IP address: 203.0.113.10
Source MAC address: 00-1A-2B-3C-4D-5E
Access time: 2026 Jan. 15 23:45 (JST)
Estimated location: East Coast of North America
Protocol: HTTPS (port 443)
User agent: Mozilla/5.0 (Windows NT 10.0; Win64; ×64)
Normal access pattern: weekdays 09:00-18:00, from Japan

Decide whether the purpose of this access seems legitimate, and classify the risk level of unauthorized access as low, medium, or high.

Provide three reasons for your judgment.”

Server then passes this prompt sentence to a generative AI model implemented as a transformer-based large language model loaded via the deep learning framework. The generative AI model internally comprises multiple attention layers, feed-forward layers, and embedding layers. Server uses a tokenizer to map the prompt sentence into integer token identifiers and arranges them into a tensor data structure in main memory or GPU memory.

Server executes the forward pass of the generative AI model to generate an output token sequence. Server configures generation parameters such as maximum sequence length, temperature, and sampling strategy (for example, top-k or nucleus sampling) to control diversity and determinism. Server decodes the output tokens back into a text string that contains an evaluation of the purpose of the access and the risk level.

Server applies deterministic parsing rules, including regular expressions and keyword dictionaries, to extract specific semantic fields from the model output: at least a risk level label (for example, “low”, “medium”, “high”) and structured reasons. Server maps the extracted risk label to a numerical risk score, such as 1 for low, 2 for medium, and 3 for high. Server stores the full output text and the risk score in fields associated with the corresponding access information record.

Server maintains unauthorized access information storage as one or more database tables indexed by network-related attributes such as IP address, domain name, user-agent string, and device identifier. Each entry includes metadata such as incident count, last incident timestamp, and an associated severity index. Server queries this storage for records matching keys in the current access information record. Server computes a malicious history score by aggregating incident counts and recency, using a defined function that assigns higher scores to repeated, recent incidents. Server appends this score and a boolean indicator of presence or absence of unauthorized history to the access information record.

Server also maintains emotion pattern storage as one or more tables containing fraudulent emotional expression patterns. Server stores, for each pattern, an emotion label (for example, urgency, fear, threat, request for confidential information), one or more representative phrase sets, and a feature vector representation. Server generates feature vectors using an embedding model such as a transformer-based sentence encoder. Server loads these vectors into memory for similarity calculation.

Server extracts user message text from relevant access information records, such as email message bodies or form submissions. Server computes a feature vector for each user message using the embedding model. Server calculates similarity between the user message vector and each fraudulent pattern vector using a distance function such as cosine similarity. Server identifies the maximum similarity, compares it to a configurable threshold, and sets a social engineering suspicion flag when the threshold is exceeded. Server stores the maximum similarity value as a fraud similarity score and associates it with the access.

Server also uses a separate text emotion classification model to classify the user message into categories such as “urgency-inducing”, “fear-inducing”, or “neutral”. The text emotion classification model may be implemented as a transformer classifier fine-tuned using cross-entropy loss over labeled training data. During training, Server or an external training environment optimizes model parameters by backpropagating errors computed between predicted labels and ground-truth labels. The model architecture, once trained, is deployed in Server for inference only.

Server additionally analyzes emotional characteristics of user messages via a generative AI model using a dedicated prompt sentence. For example, Server constructs: “You are a security analyst.

Read the following message and describe its emotional characteristics.

Specifically, determine whether it contains expressions that urge the recipient to act quickly, cause fear, or request money or authentication information.

Also evaluate whether it resembles typical special fraud or phishing attack patterns.

Message: ‘Please send your account information immediately. If you do not, your account will be frozen and all data will be lost. Respond urgently.’”

Server inputs this prompt sentence into the generative AI model, obtains a textual explanation, and then uses parsing rules to detect keyphrases such as “creates a sense of urgency”, “induces fear of loss”, and “requests sensitive information”. Server encodes the presence and intensity of these phrases into a feature vector aligned with the dimensions used in the emotion pattern storage. Server reuses the similarity computation logic to refine the fraud similarity score and the social engineering suspicion flag.

Terminal captures audio signals from the administrator through the microphone. Terminal packetizes the audio and transmits it to Server over the network. Server uses the audio processing library to transform audio signals into a time-frequency representation, such as Mel-spectrograms, and then derives Mel-frequency cepstral coefficients (MFCCs) and other acoustic features. Server normalizes these features and inputs sliding windows of feature frames into an audio emotion recognition model.

In an embodiment, Server implements the audio emotion recognition model as a neural network including convolutional layers followed by recurrent layers such as long short-term memory units and a final fully connected classification layer. During training in an external environment, the model is optimized using a supervised learning algorithm with a cross-entropy loss function, updated through a gradient-based optimizer such as Adam. Data augmentation techniques such as random time-shifting, additive noise, and pitch shifting may be applied to improve robustness. This trained model is then deployed in Server for inference.

Server obtains per-window predictions of emotional categories such as “calm”, “stressed”, or “high stress”, and converts them into a continuous stress-level index by weighting probabilities and applying a mapping function to a 0-100 scale. Server further processes administrator text input transmitted from Terminal using the text emotion classification model, producing labels such as “anxiety”, “irritation”, or “neutral” with associated confidence scores. Server combines the audio-derived stress index and the text-based emotion probabilities through a fusion rule or a simple neural fusion layer to form a single emotion index representing the administrator's current emotional state.

Server maintains, in memory or in a session table, the emotion index associated with the administrator session. Server uses this emotion index to categorize the administrator into states such as “low stress”, “medium stress”, or “high stress” based on configurable thresholds. Server then uses the category as a parameter for user interface adaptation. Server aggregates, for each access, the AI risk score, malicious history score, unauthorized-history flag, fraud similarity score, social engineering suspicion flag, administrator emotion index, and additional emotional features extracted from user messages. Server constructs a composite prompt sentence summarizing these metrics and requesting a control policy proposal from the generative AI model. For example:

“You are responsible for deciding access control policies in a corporate network.

Using the information below, determine a recommended control policy that minimizes the risk of mistaken approval.
AI risk score: 3 (high)
Unauthorized access DB: source IP has past malicious access records
Fraud similarity score: 0.9 (strong similarity to phishing patterns)
Social engineering suspected: yes
Administrator emotional state: stress level 85 (high stress)

### Propose:

1) Whether to automatically block, temporarily block, or allow the access,
2) Whether to require additional authentication, and
3) A concise recommendation message to show to the administrator on the console.”

Server inputs this prompt sentence into the generative AI model, executes inference, and obtains a textual control policy proposal. Server parses the proposal using rule-based extraction, identifying terms indicating automatic blocking, temporary blocking, allowing with additional authentication, or other specific actions. Server converts these elements into a structured access control policy object, represented internally as a data structure specifying action type, scope (such as IP range or port set), duration, and additional requirements (such as multi-factor authentication).

Server then converts the access control policy object into device-specific configuration commands. When Server controls a firewall, Server may generate rule commands for a packet filter engine. These commands may specify, for example, dropping new connections from a specific source IP for a defined time window, or requiring redirection to an authentication gateway. When Server controls a router or switch, Server may modify access control lists. The communication control apparatus receives these commands via a management interface and applies them to hardware forwarding tables or software filtering rules.

Server generates user interface control information based on both the access control policy and the administrator emotion index. When the emotion index indicates high stress, Server selects a simplified user interface layout that reduces the number of visible options and presents a small set of clearly labeled actions. Server assembles a UI specification including a short warning message, a summarized rationale, and only limited buttons such as “Temporary Block” and “Allow After Verification”. When the emotion index indicates low stress, Server selects a detailed layout, including expanded technical details, full AI explanation text, historical statistics, and a larger set of control options.

Server sends the UI specification to Terminal, which renders the interface. User views the interface on the display. User selects one of the recommended or alternative actions using the input device. Terminal transmits the selected operation input back to Server. Server validates the operation input against the current access control policy and may update firewall rules or gateway configurations accordingly. Server logs both the AI-recommended policy and the final human-selected action for future analysis.

Server records incident data by creating an incident record in the database. The incident record references the access identification and includes fields for the access information record, the prompt sentences used, the outputs of the generative AI model, the emotion indices for both user and administrator (when applicable), the computed risk level, the access control policy object, the UI configuration applied, the actual operation input from the administrator, and the resulting enforcement changes to the communication control apparatus. Server uses a normalized schema to store these attributes in multiple tables connected by foreign keys.

Server periodically executes aggregation queries or batch processes to generate statistical information. Server computes metrics such as counts of high-risk accesses, distributions of fraud similarity scores, correlation between administrator stress levels and frequency of misclassified accesses, and effectiveness of different UI modes in reducing errors. Server exposes this statistical information through an administrative dashboard. Terminal, when operated by a user acting as a security analyst, retrieves and displays graphs and reports. This structured logging and analysis pipeline allows software engineers and security operators to adjust thresholds, refine templates, or update model configurations for improved performance. This embodiment improves computer technology in multiple ways. By using a generative AI model with structured prompt sentences that embed both technical and emotional indicators, Server enhances the expressiveness and adaptivity of the risk-evaluation pipeline beyond conventional static rules or simple classifiers. This integration reduces false negatives for subtle social-engineering attacks and reduces false positives by contextualizing unusual patterns. By computing a unified risk level and using it to automatically drive device-level rule updates, Server decreases the latency between detection and enforcement, improving real-time responsiveness of the communication control apparatus.

By dynamically adjusting UI complexity based on the administrator emotion index, Server reduces cognitive load during high-stress conditions, which in turn reduces the frequency of erroneous decisions that could lead to security breaches or unnecessary disruptions. This behavior is not a simple automation of human work; rather, it modifies internal system behavior-specifically, allocation of display resources, action defaults, and interaction workflows-in response to measured state, thereby improving human-computer interaction at the system level.

By storing prompt sentences, generative AI outputs, and emotion indices as structured incident attributes, Server enables machine-based analysis that was not feasible with traditional logging. This data model supports learning-based optimization of thresholds and UI strategies, leading to iterative improvement of detection accuracy and operator efficiency. Because Server uses efficient vector operations, hardware acceleration, and compressed representations where appropriate, the system achieves higher processing throughput and lower latency than naive implementations that would attempt to evaluate similar features using human operators or simplistic text processing.

In alternative embodiments, Server may employ different neural network architectures for the generative AI model, such as encoder-decoder transformers or mixtures of experts, and may adjust training objectives, such as incorporating custom loss terms favoring consistent risk labeling. Server may also use different similarity metrics for emotion pattern matching, such as Euclidean distance or learned metric embeddings. Server may change the internal representation of the access control policy object, for example, from a simple rule list to a policy graph, while still performing device-level configuration updates based on the policy. Terminal may be implemented as a mobile device, a thin client, or an integrated console display of a network appliance, and the communication control apparatus may be realized as a hardware firewall, a software-defined networking controller, or a virtual network function. In all such embodiments, Server, Terminal, and User cooperate to execute a technically grounded, computer-implemented process in which access information, historical data, and emotional signals are transformed through specific data structures, neural architectures, and rule-based extraction pipelines into device-level control commands and adaptive user interfaces, thereby improving the operation of the computer network and the safety and reliability of access-control decisions.

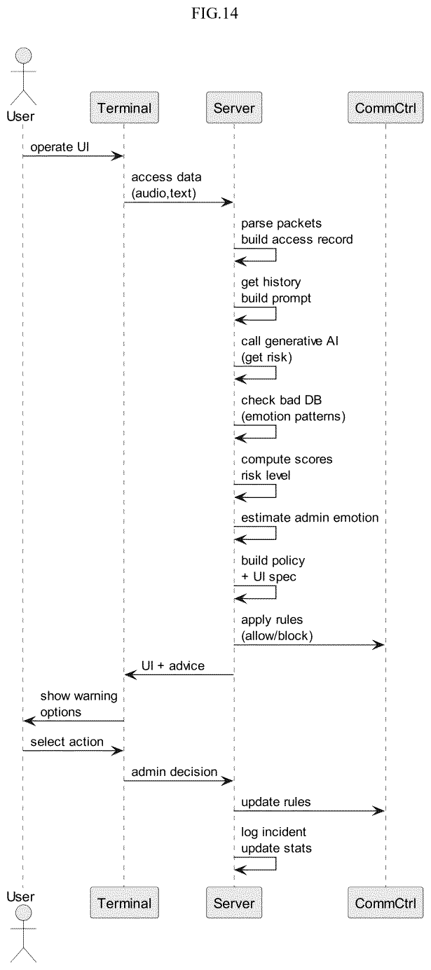

The following describes the processing flow using FIG. 14.

### Step 1:

Server uses a network interface and a packet processing library to capture communication information on a communication path.

Server receives, as input, raw packets containing layer-2, layer-3, and layer-4 headers and payloads. Server decodes Ethernet, IP, and TCP/UDP headers to extract fields such as source IP address, destination IP address, source port, destination port, protocol type, and timestamp. Server queries an address resolution table or a network device API to obtain a source device identifier such as a MAC address. Server calls an IP geolocation database with the source IP address to obtain a geographic location. Server outputs a partially populated access information object that includes network-layer attributes and geolocation data.

### Step 2:

Server analyzes the application-layer portion of the captured packets to extract user-facing message content and metadata.

Server uses, as input, the partially populated access information object and the packet payload bytes. Server checks port numbers and protocol signatures to determine whether the payload corresponds to protocols such as HTTP(S) or email protocols. Server applies an HTTP parsing routine or an email parsing routine to extract headers such as user-agent, sender address, subject line, and textual body segments. Server normalizes character encodings to a unified text format and truncates overly long bodies to a configured length. Server outputs a complete access information record that includes network headers, geolocation, application headers, and an optional user message text.

### Step 3:

Server retrieves usage history information for the same access source and aggregates it into summary statistics.

Server uses, as input, identifiers from the access information record, such as source IP address, source device identifier, and user account identifier. Server queries a relational database for past access entries associated with these identifiers. Server computes aggregated metrics such as typical access time ranges, common geographic regions, most frequently used protocols, and historical risk scores. Server then stores these aggregates as a usage history structure linked to the access source. Server outputs the usage history structure to be used in later risk evaluation and prompt construction.

### Step 4:

Server constructs a prompt sentence in a natural language by combining current access information with usage history information.

Server uses, as input, the access information record and the usage history structure. Server loads a template string from a configuration storage, where the template contains placeholders for access attributes and historical attributes. Server replaces each placeholder with concrete values, for example, inserting the source IP address, access time, estimated location, protocol, user-agent, and typical past access pattern. Server concatenates fixed explanatory text and questions with these values to form a coherent prompt sentence. Server outputs a fully rendered prompt sentence suitable for input to a generative AI model.

### Step 5:

Server evaluates the access using a generative AI model and derives a risk score.

Server uses, as input, the prompt sentence generated in Step 4. Server employs a tokenizer from a natural language processing library to convert the prompt sentence into token identifiers and arranges them into a tensor. Server loads a transformer-based generative AI model via a deep learning framework on CPU or GPU. Server runs an inference routine, which processes the token tensor through embedding layers, attention blocks, and feed-forward layers to generate an output sequence of token identifiers. Server decodes the output tokens back into a natural-language response that includes a risk-level description and reasoning. Server applies regular expressions and keyword matching to extract a categorical risk label such as “low”, “medium”, or “high”. Server maps this label onto a numerical scale, for example, low=1, medium=2, high=3. Server outputs the generative AI model's response text and the numerical AI risk score.

### Step 6:

Server enriches the access information record with the AI risk score and structured reasons.

Server uses, as input, the access information record and the AI risk score with the associated response text. Server parses the response text to detect references to abnormal factors such as unusual time, unusual location, or unfamiliar user-agent string, using keyword dictionaries and pattern rules. Server records each detected factor as a tagged attribute in the access information record. Server inserts or updates fields for the AI risk score and abnormality tags in the relational database. Server outputs an updated access information record that now includes AI-derived evaluation features.

### Step 7:

Server checks the access against unauthorized access information storage to determine historical maliciousness.

Server uses, as input, the updated access information record. Server issues database queries against an unauthorized access information storage table, using primary keys such as source IP address, domain name, user-agent, or device identifier. Server retrieves matching records containing past incident counts and timestamps. Server calculates a malicious history score by applying a function that increases the score with higher incident counts and more recent incidents. Server sets a “has malicious history” flag when at least one matching entry is found. Server appends the malicious history score and flag to the access information record and outputs the augmented record.

### Step 8:

Server evaluates similarity between the user message and stored fraudulent emotional expression patterns.

Server uses, as input, the user message text from the access information record and the emotion pattern storage containing fraudulent pattern vectors and labels. Server passes the user message text through an embedding model to obtain a numerical feature vector representing semantic and emotional content. Server retrieves fraudulent pattern vectors from memory and computes similarity scores between the user message vector and each pattern vector using a metric such as cosine similarity. Server identifies the maximum similarity and compares it with a predefined threshold. If the maximum similarity exceeds the threshold, Server sets a social engineering suspected flag. Server writes the maximum similarity as a fraud similarity score and associates the label of the closest fraudulent pattern with the access. Server outputs the access information record enriched with fraud similarity and social engineering suspicion indicators.

### Step 9:

Terminal acquires administrator audio and text inputs and transmits them to Server for emotion estimation.

Terminal uses, as input, voice signals captured by a microphone and text typed by User into a user interface. Terminal digitizes audio into frames of samples, packages audio frames and text strings into network messages, and sends them securely to Server. Terminal does not perform emotion analysis locally but simply forwards data. Terminal outputs audio data packets and text messages targeted to Server.

### Step 10:

Server estimates the administrator's emotional state using audio and text analysis.

Server uses, as input, audio data packets and text messages received from Terminal. For audio, Server applies an audio processing library to segment recordings into time windows and extracts features such as Mel-frequency cepstral coefficients, spectral bandwidth, and energy. Server normalizes these features and inputs them to a neural-network-based audio emotion recognition model to obtain probabilities for categories such as calm, stressed, and high stress. For text, Server passes each message through a text emotion classifier model to obtain labels such as anxiety, irritation, or neutral, with confidence scores. Server combines these results by computing a weighted sum or feeding them into a fusion layer to produce a single numeric stress level on a chosen scale and an associated emotion label. Server stores this combined value as an emotion index for the administrator session and outputs the current administrator emotion index.

### Step 11:

Server analyzes emotional characteristics of the access-originating user message to refine fraud indicators.

Server uses, as input, the user message text and, optionally, previously computed emotion features for the user message. Server constructs a specialized prompt sentence asking the generative AI model to describe emotional aspects such as urgency, fear, and requests for confidential information. Server sends this prompt sentence to the generative AI model and receives a detailed textual analysis. Server parses the analysis for keyphrases such as “urges immediate action”, “creates fear of loss”, or “asks for sensitive credentials”. Server encodes the presence and intensity of these keyphrases into an emotional feature vector with dimensions corresponding to predefined emotional categories. Server recomputes similarity between this feature vector and fraudulent patterns stored in emotion pattern storage, adjusting the fraud similarity score and social engineering suspected flag as necessary. Server outputs updated emotional features and fraud indicators for the access.

### Step 12:

Server integrates all risk and emotion indicators into a unified risk level.

Server uses, as input, the AI risk score, malicious history score, unauthorized-history flag, fraud similarity score, social engineering suspected flag, administrator emotion index, and emotional feature vector for the user message. Server may apply a rule engine that uses thresholds and weights to compute a composite risk level or may prepare an integrated prompt sentence summarizing all indicators and request a risk classification from the generative AI model. In either case, Server calculates a final numeric risk level, for example on a scale from 0 to 100, and optionally maps it back to categories such as low, medium, or high. Server records the unified risk level in the access information record and outputs this risk level along with supporting indicators.

### Step 13:

Server generates a control policy proposal using a generative AI model based on integrated indicators.

Server uses, as input, the unified risk level and other indicators such as malicious history, fraud similarity, social engineering suspicion, and administrator emotion index. Server constructs a prompt sentence that lists these indicators in natural language and requests a recommended control policy, including whether to allow, temporarily block, or block, whether to request additional authentication, and what message to show to the administrator. Server supplies this prompt sentence to the generative AI model and runs inference. Server receives a natural-language control policy proposal, including recommended actions and reasoning. Server parses the proposal to extract structured directives such as “temporarily block for 10 minutes” or “require multi-factor authentication”. Server outputs a preliminary control policy object containing action type, duration, and extra requirements, and a text recommendation message.

### Step 14:

Server converts the control policy proposal into device-specific access control rules and UI control information.

Server uses, as input, the preliminary control policy object, the text recommendation message, and the administrator emotion index. Server translates high-level actions into device-specific rule specifications, such as firewall rules or gateway policies, encoded as data structures or command strings. Server also generates UI control information by selecting an interface mode according to the emotion index: for high stress, Server selects a simple mode with minimal options; for low stress, Server selects a detailed mode with more choices. Server constructs a UI specification that includes warning text, the recommendation message, and a defined set of operation buttons or menu items. Server outputs device rule specifications for communication control and UI specifications for Terminal.

### Step 15:

Server enforces communication control by updating configuration of a communication control apparatus.

Server uses, as input, the device rule specifications derived in Step 14. Server interfaces with a firewall, router, or other communication control apparatus via a management API, command-line interface, or protocol. Server sends commands to add, update, or remove rules that match the characteristics of the suspicious access, such as source IP and port. Server may, for example, install a rule that drops new connections from a specific address for a certain time or redirects such connections to an authentication service. Server verifies success or failure responses from the communication control apparatus and logs these results. Server outputs the updated enforcement state of the network device.

### Step 16:

Terminal presents an adaptive user interface to the administrator and collects final decisions.

Terminal uses, as input, the UI specification sent by Server. Terminal renders warning messages, recommended operation procedures, and operation input interfaces such as buttons labeled “Temporary Block”, “Permanent Block”, or “Allow After Verification”. Terminal adjusts the amount of detail and the number of visible options according to the specification, so that in high-stress mode, Terminal shows fewer, clearer options. User views the interface and selects a desired action using the input device. Terminal converts this selection into an operation input message and transmits it back to Server. Terminal outputs the administrator's selected operation input.

### Step 17:

Server applies the administrator's decision to refine control policies and logs the outcome.

Server uses, as input, the operation input from Terminal, the currently enforced policy, and the previously generated control policy object. Server compares the administrator's selection with the automatically recommended policy. If the administrator's choice changes the action, Server adjusts firewall rules or gateway policies accordingly, for example extending a temporary block into a permanent block or lifting a restriction after verification. Server records both the recommended policy and the actual executed policy in the access information record and the incident record. Server outputs the final applied policy and enforcement changes.

### Step 18:

Server creates and updates incident records and generates statistical information.

Server uses, as input, the access information record, all prompt sentences, all generative AI outputs, emotion indices, risk levels, control policies, enforcement logs, and administrator operation inputs produced during processing of an access. Server aggregates this information into a normalized set of tables keyed by an incident identifier, thereby creating or updating an incident record. Server then runs periodic aggregation queries over incident records to compute statistics such as the number of high-risk accesses, distribution of social engineering suspicion flags, correlation between administrator stress levels and error rates, and efficiency of different UI modes. Server outputs incident records stored in the database and statistical summaries made available to dashboards and analysis tools.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

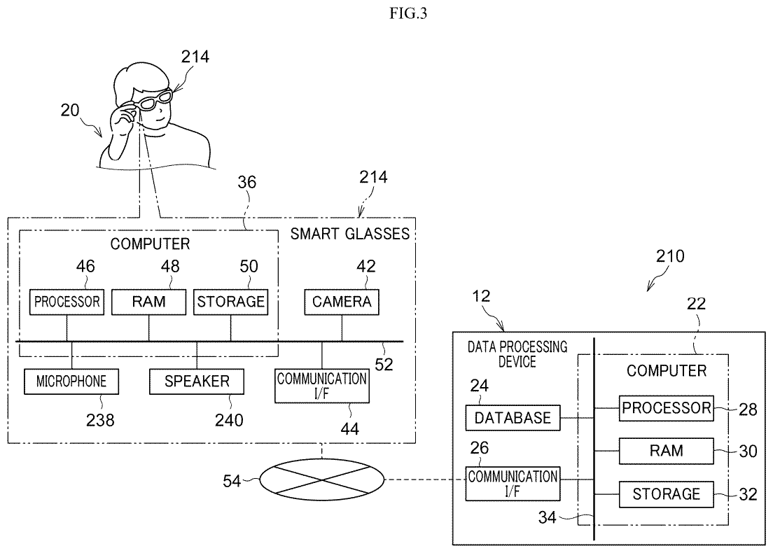

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

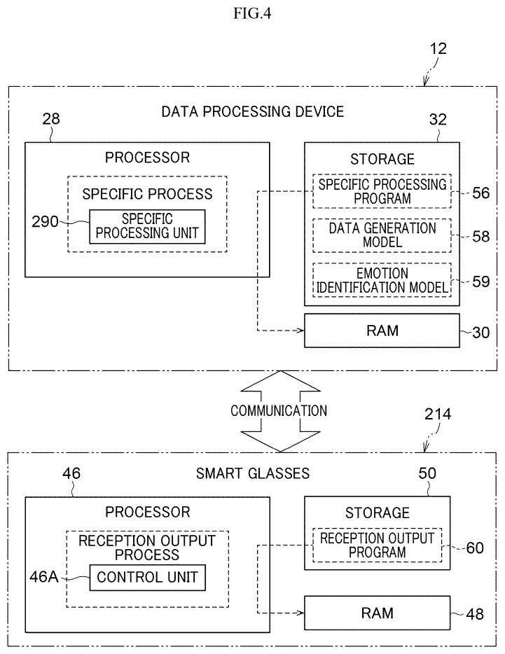

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

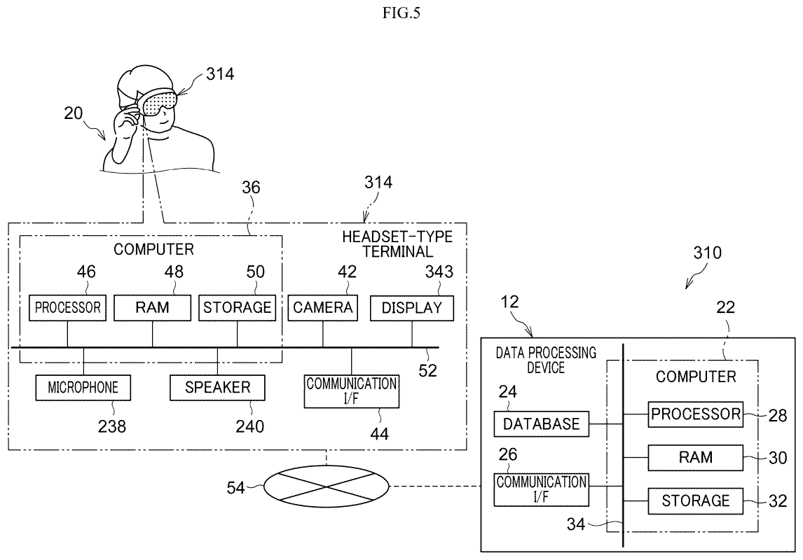

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

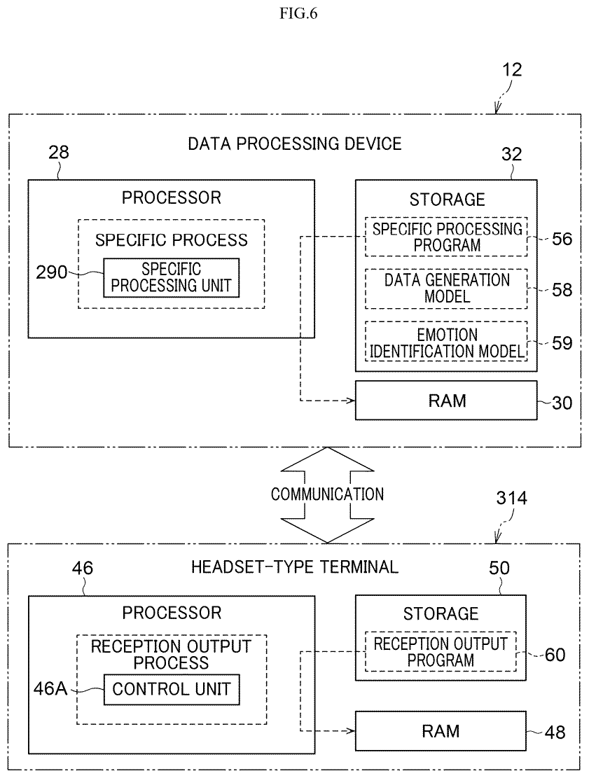

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

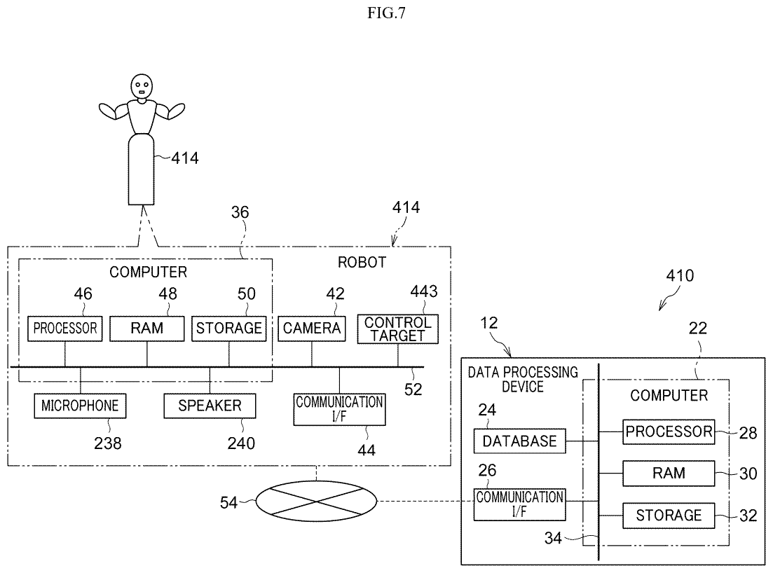

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

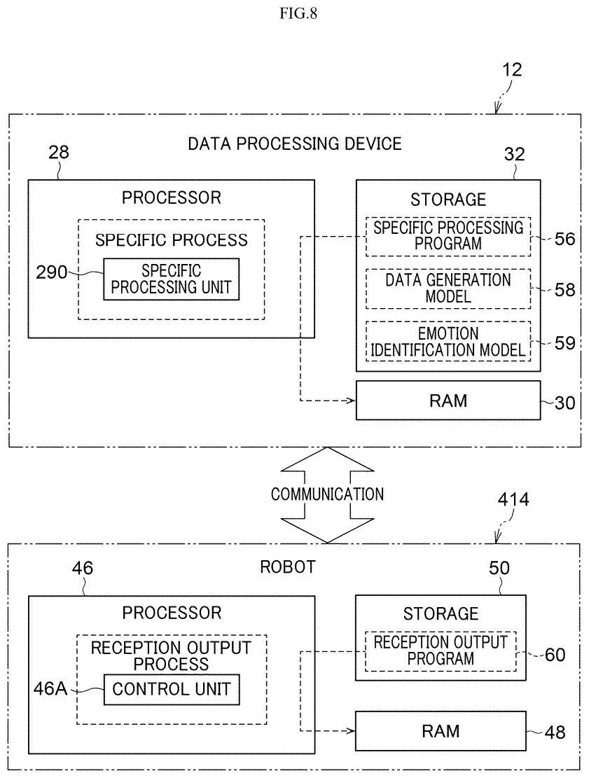

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

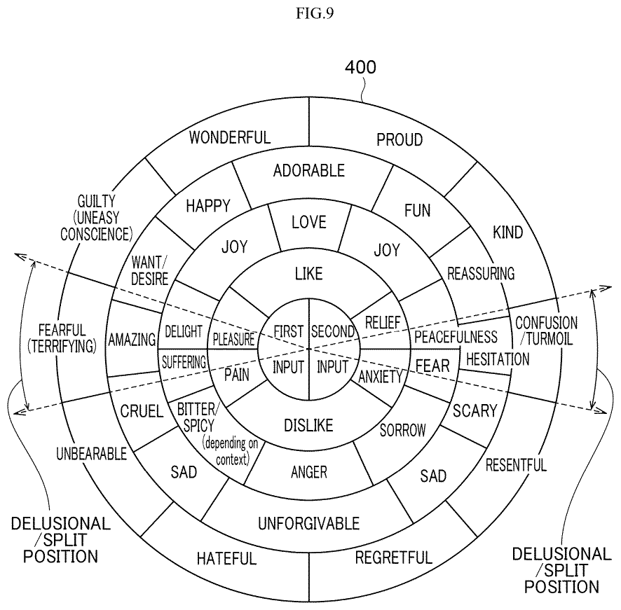

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

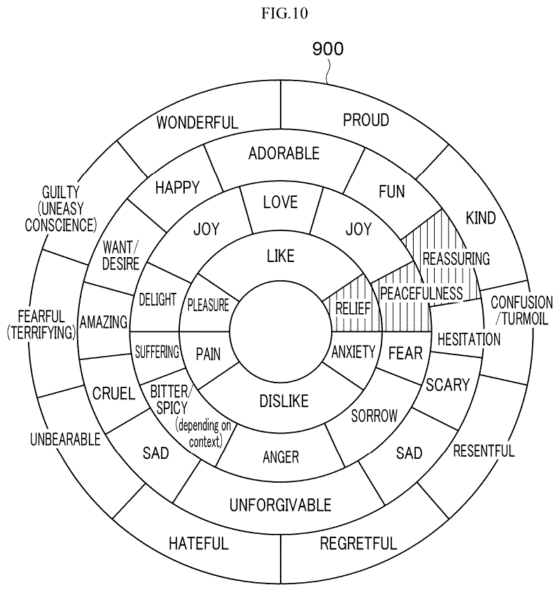

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to acquire input information from a user, generate a prompt sentence for a generative AI model, transmit to the generative AI model an analysis request including the input information and transaction information, receive a response from the generative AI model, and generate a semantic interpretation result including relationship information, urgency information, and fraud risk information on the basis of the response and the content of the user's utterance, compare the semantic interpretation result with fraud-related information and transaction history information stored in an external storage device, determine whether a transaction corresponds to a transaction pattern that is different from a usual pattern for the user, and perform a comprehensive fraud risk evaluation of the transaction,
when the comprehensive fraud risk evaluation satisfies a predetermined condition, transmit control information including warning information and additional question prompt sentences to a transaction terminal, temporarily restrict progress of transaction processing at the transaction terminal, acquire responses of the user to the additional questions from the transaction terminal, and trigger a re-evaluation by the generative AI model on the basis of the responses, and
generate log information including the warning information, the additional questions, responses of the generative AI model, a collation result with the fraud-related information, and a final transaction selection of the user, store the log information in a storage device, and make the log information reportable to an external organization in accordance with a predetermined condition.

### (Supplementary 2)

The system according to supplementary 1,
wherein the processor is configured to
generate, as the prompt sentence to be transmitted to the generative AI model, a sentence including the content of the user's utterance, a transaction amount, anomaly information based on past transaction history, and information regarding known fraud patterns, and dynamically update warning statements to be presented to the user and question statements prompting additional input from the user on the basis of an output obtained from the generative AI model.

### (Supplementary 3)

The system according to supplementary 1,
wherein the processor is configured to
when the comprehensive fraud risk evaluation is determined to be high risk, disable a transaction execution operation at the transaction terminal, present to the user an interactive series of questions that promotes cooling of a psychological state of the user on the basis of an output of the generative AI model, input responses of the user to the question series again into the generative AI model to update the fraud risk evaluation, and determine a final permission or prohibition of the transaction on the basis of an updated result of the fraud risk evaluation.

### Application Example 1

### (Supplementary 1)

A system comprising a processor,
wherein the processor is configured to
acquire behavior information including connection information from an information processing terminal that attempts to connect to a communication network, the connection information including at least one of a network address, a device identifier, a communication protocol, a connection time, and a geographic location associated with the information processing terminal,
generate a prompt sentence for a generative AI model by using the connection information and the behavior information, input the prompt sentence into the generative AI model, and acquire, in a natural language form, evaluation information regarding at least a purpose of the connection, a reliability of the information processing terminal, and whether the connection deviates from a normal behavior pattern, and generate numerical information indicating a risk level of the connection based on the evaluation information,
compare, in real time, identification information including at least a part of the connection information with fraud-related information and communication identifier information stored in an external storage device that stores information related to wrongful acts, determine whether the identification information matches the fraud-related information, and determine a possibility of the wrongful act by associating a result of the determining with the evaluation information and the numerical information,
output control information to a communication control device to temporally restrict the connection from the information processing terminal when the possibility of the wrongful act is determined to exceed a predetermined criterion, output notification information indicating that the connection is possibly related to the wrongful act and explanation information including at least a part of the evaluation information to a user display device, and output an instruction of permitting or blocking the connection to the communication control device in accordance with permission information or blocking information received from a user, access the external storage device by using encrypted communication and periodically acquire or update the fraud-related information and the communication identifier information, and store, as history information for later analysis, at least the connection information, the prompt sentence, the evaluation information and the numerical information acquired from the generative AI model, a determination result of the comparison, control information output to the communication control device, and the permission information or the blocking information received from the user.

### (Supplementary 2)

The system according to supplementary 1,
wherein the processor is configured to
when acquiring the evaluation information and the numerical information, acquire, as the behavior information, history information including at least one of an identifier of the information processing terminal, usage history information of the information processing terminal, past connection time band information of the user, normal geographic connection range information of the user, and normal communication method information of the user, include the history information in the prompt sentence, input the prompt sentence into the generative AI model, and cause the generative AI model to evaluate whether the connection is normal or not with respect to the history information.

### (Supplementary 3)

The system according to supplementary 1,
wherein the processor is configured to
when the possibility of the wrongful act exceeds the predetermined criterion, present, via the user display device, inquiry information that prompts the user to input additional information regarding at least a purpose of the connection, a relationship with the information processing terminal, and a necessity of the connection, generate, from the additional information acquired from the user, an additional prompt sentence to be input into the generative AI model, input the additional prompt sentence into the generative AI model, acquire a re-evaluation result from the generative AI model, and re-determine whether to maintain, release, or strengthen a restriction state of the connection based on the re-evaluation result.

### Example 2

### (Supplementary 1)

A system comprising a processor,
wherein the processor is configured to
acquire, from a terminal device, transfer-related numerical information and character information, and voice information, image information, and operation history information, perform speech recognition processing on the voice information to generate text information representing utterance content, and generate a prompt sentence for a generative AI model based on the text information representing the utterance content and the transfer-related numerical information and character information, and input the prompt sentence to the generative AI model to obtain response information including a fraud risk evaluation result and at least one additional question sentence,
and query a first information storage apparatus in which fraud-related transaction information is stored and a second information storage apparatus in which a plurality of transaction histories are stored, based on the transfer-related numerical information and character information and attribute information relating to a user, and generate matching result information indicating a fraud risk relating to a transfer transaction based on query results, and estimate an emotional state of the user based on at least part of the voice information, the image information, and the operation history information by using an acoustic feature extraction program, an image feature extraction program, and an operation feature extraction program, and generate emotional information indicating the emotional state,
and determine a comprehensive fraud risk level for the transfer transaction based on the fraud risk evaluation result obtained by the generative AI model, the matching result information, and the emotional information, and, in accordance with a determination result, determine warning information to be displayed or output as sound by the terminal device and at least part of the at least one additional question sentence, and control continuation or temporary suspension of transfer operation at the terminal device,
and record, in an information storage apparatus, the fraud risk evaluation result, the matching result information, the emotional information, and control content by the processor in association with the transfer transaction.

### (Supplementary 2)

The system according to supplementary 1,
wherein the processor is configured to
generate the prompt sentence by including the emotional information generated based on the voice information, the image information, and the operation history information, and the matching result information generated based on the query of the information storage apparatuses, in the prompt sentence, and obtain, from the generative AI model, a numerical score relating to the fraud risk, one or more explanatory reasons corresponding to the numerical score, and a plurality of additional question sentences to be presented to the user at the terminal device, in a predetermined output format.

### (Supplementary 3)

The system according to supplementary 1,
wherein the processor is configured to
acquire answer information from the terminal device regarding the at least one additional question sentence presented to the user, re-evaluate the comprehensive fraud risk level by integrating the answer information with the fraud risk evaluation result, the matching result information, and the emotional information, determine permission, restriction, or cancellation of the transfer operation based on a re-evaluation result, and, when the user attempts to ignore warning information, cause the terminal device to present additional warning information and a confirmation procedure.

### Application Example 2

### (Supplementary 1)

A system comprising a processor,
wherein the processor is configured to
acquire access information from communication information passing through a communication path,
generate a prompt sentence in a natural language including the access information and usage history information, input the prompt sentence to a generative AI model, execute natural language processing by the generative AI model, and obtain an evaluation result regarding a purpose of access and a reliability of an access source apparatus,
compare the access information with unauthorized access information storage that stores unauthorized access information and emotion pattern storage that stores fraudulent emotional expression patterns, and obtain a comparison result based on presence or absence of a match or similarity with the unauthorized access information and the fraudulent emotional expression patterns,
perform emotion estimation processing on a user message included in the access information or on voice input or text input from an administrator, and calculate an emotion index indicating emotional states of a user and the administrator,
integrate the evaluation result of the generative AI model, the comparison result, and the emotion index, calculate a risk level of the access, determine an access control policy according to the risk level, and generate control information that dynamically changes information presentation content and information presentation format according to an emotional state of the administrator,
control a communication control apparatus based on the access control policy so as to permit, restrict, or block the access,
present warning information, recommended operation procedures, and an operation input interface to an administrator display apparatus based on the control information, and acquire, via the operation input interface, operation input from the administrator regarding permission or blocking, and
store the access information, the prompt sentence, output of the generative AI model, the emotion index, the access control policy, and the operation input as an incident record, and generate statistical information based on the incident record.

### (Supplementary 2)

The system according to supplementary 1,
wherein the processor is configured to
use an audio processing program and an emotion classification machine learning model to extract acoustic feature quantities from voice data of the administrator and to numerically express a stress level of the administrator based on the acoustic feature quantities, use a text emotion analysis machine learning model to estimate an emotion label from text input of the administrator,
integrate the stress level and the emotion label to generate the emotion index, and control, according to the emotion index, an amount of display of detailed information and a number of operation options so that, when the administrator is in a high-stress state, only simplified action guidelines and limited operation buttons are displayed by switching a user interface.

### (Supplementary 3)

The system according to supplementary 1,
wherein the processor is configured to
generate the prompt sentence by enumerating in the natural language a plurality of risk-related indices including the access information, unauthorized access history information, emotional feature quantities of a user message, and the emotion index of the administrator, and input the prompt sentence to the generative AI model to obtain, in the natural language, a control policy proposal including automatic control contents for the access, necessity of additional authentication, and a recommended message for the administrator, and
convert the control policy proposal into machine-processable control data by extracting the access control policy and the recommended message for the administrator from the control policy proposal.

What is claimed is:

1. A system comprising:
circuitry configured to:
receive, via a communication interface coupled to a packet-switched network, a data packet from a terminal device coupled to the packet-switched network;
perform natural language processing on payload data extracted from the data packet to generate a feature vector representing a semantic interpretation including at least a relationship label, an urgency label, and a classification label;
construct a prompt data structure encoding the feature vector and transmit the prompt data structure to a generative neural network model via an inference interface;
receive, from the generative neural network model, inference output data including an evaluation score and at least one query data structure;
transmit a query message via the communication interface to at least one external storage device coupled to the packet-switched network, and receive a comparison result indicating whether the payload data corresponds to a pattern that deviates from a baseline pattern stored in the at least one external storage device;
compute a composite score based on the evaluation score, the comparison result, and historical data retrieved from a database coupled to the packet-switched network;
when the composite score satisfies a predetermined threshold, transmit, via the communication interface, a control message including a notification payload and the at least one query data structure to the terminal device, and set a state flag that restricts execution of a pending operation at the terminal device;
receive, via the communication interface, a response message from the terminal device, construct an updated prompt data structure including data from the response message, and transmit the updated prompt data structure to the generative neural network model to obtain updated inference output data; and
write, to a log storage coupled to the packet-switched network, a record associating the prompt data structure, the inference output data, the comparison result, and the control message with a session identifier.

2. The system according to claim 1, wherein the natural language processing includes tokenization, parsing, and semantic analysis of the payload data, and wherein the feature vector further includes an intent recognition result derived from the semantic analysis.

3. The system according to claim 1, wherein the prompt data structure includes a structured text sequence comprising a plurality of field identifiers, each field identifier associated with a respective value derived from the feature vector, transaction parameters extracted from the data packet, and anomaly information derived from the historical data.

4. The system according to claim 1, wherein the generative neural network model comprises a transformer-based architecture including an embedding layer, a plurality of self-attention layers, a plurality of feed-forward layers, and an output projection layer.

5. The system according to claim 1, wherein the circuitry is further configured to parse the inference output data using a deterministic parser to extract the evaluation score, one or more explanatory text segments, and the at least one query data structure as structured fields from a natural language response generated by the generative neural network model.

6. The system according to claim 1, wherein the at least one external storage device stores at least one of a list of flagged account identifiers, a list of flagged communication identifiers, and records of known anomalous patterns, and wherein the comparison result includes at least one of a match flag and a similarity score.

7. The system according to claim 1, wherein the circuitry computes the composite score by applying a weighted combination of the evaluation score, the comparison result, and a deviation metric derived from comparing a current operation parameter against a statistical distribution of the historical data.

8. The system according to claim 1, wherein the circuitry is further configured to, after obtaining the updated inference output data, recompute the composite score based on the updated inference output data and determine whether to maintain or release the state flag that restricts execution of the pending operation.

9. The system according to claim 1, wherein the data packet includes connection information comprising at least one of a network address, a device identifier, a communication protocol type, a connection timestamp, and a geographic location associated with the terminal device.

10. The system according to claim 9, wherein the circuitry is further configured to generate the prompt data structure by encoding the connection information and usage history information including at least one of a typical connection time range, a typical geographic region, and a list of previously used device identifiers associated with a user of the terminal device.

11. The system according to claim 9, wherein the circuitry is further configured to transmit a control command to a communication control apparatus coupled to the packet-switched network to at least one of temporarily block, rate-limit, or redirect network traffic associated with the terminal device based on the composite score.

12. The system according to claim 9, wherein the circuitry accesses the at least one external storage device via encrypted communication to periodically acquire updated reference information including at least one of blacklist entries and threat intelligence records.

13. The system according to claim 1, wherein the circuitry is further configured to:
receive, via the communication interface, at least one of voice data, image data, and operation history data from the terminal device; and
estimate an emotional state of a user of the terminal device based on the at least one of the voice data, the image data, and the operation history data using an emotion classification model.

14. The system according to claim 13, wherein the circuitry estimates the emotional state by extracting acoustic features including at least one of Mel-frequency cepstral coefficients, fundamental frequency, and energy from the voice data, extracting facial expression features from the image data using a convolutional neural network, and extracting behavioral features including at least one of inter-event time intervals and correction operation counts from the operation history data.

15. The system according to claim 13, wherein the circuitry is further configured to include emotional state information in the prompt data structure before transmitting the prompt data structure to the generative neural network model, and to incorporate the emotional state information into the computation of the composite score.

16. The system according to claim 13, wherein the circuitry is further configured to dynamically adjust an information presentation format of the control message based on the estimated emotional state, including selecting between a simplified presentation mode and a detailed presentation mode for the notification payload transmitted to the terminal device.

17. The system according to claim 1, wherein the circuitry is further configured to convert voice data received from the terminal device into text data using a speech recognition engine, and to include the text data as part of the payload data subjected to the natural language processing.

18. A system comprising:
a communication interface including a network interface controller coupled to a packet-switched network and configured to transmit and receive data packets conforming to at least one of Ethernet and wireless communication protocols;
a memory storing instructions, a generative neural network model comprising an embedding layer, a plurality of self-attention layers, a plurality of feed-forward layers, and an output projection layer, and an emotion classification model; and
circuitry comprising one or more processors coupled to the memory and configured to execute the instructions to:
receive, via the communication interface, a data packet from a terminal device coupled to the packet-switched network;
perform natural language processing on payload data extracted from the data packet to generate a feature vector representing a semantic interpretation including at least a relationship label, an urgency label, and a classification label;
construct a prompt data structure encoding the feature vector and contextual parameters extracted from the data packet, and transmit the prompt data structure to the generative neural network model via an inference interface;
receive, from the generative neural network model, inference output data including an evaluation score and at least one query data structure, and parse the inference output data using a deterministic parser to extract structured fields;
transmit a query message via the communication interface to at least one external storage device coupled to the packet-switched network storing reference information including at least one of flagged identifiers and anomalous pattern records, and receive a comparison result;
compute a composite score by applying a weighted combination of the evaluation score, the comparison result, and a deviation metric derived from historical data stored in a database coupled to the packet-switched network;
when the composite score satisfies a predetermined threshold, transmit, via the communication interface, a control message including a notification payload and the at least one query data structure to the terminal device, and set a state flag that restricts execution of a pending operation at the terminal device;
receive, via the communication interface, a response message from the terminal device, construct an updated prompt data structure including data from the response message, transmit the updated prompt data structure to the generative neural network model to obtain updated inference output data, and recompute the composite score based on the updated inference output data; and
write, to a log storage coupled to the packet-switched network, a record associating the prompt data structure, the inference output data, the comparison result, the control message, and a final operation outcome with a session identifier.

19. The system according to claim 18, wherein the circuitry is further configured to receive at least one of voice data, image data, and operation history data from the terminal device via the communication interface, estimate an emotional state of a user of the terminal device based on the received data using the emotion classification model stored in the memory, and dynamically adjust an information presentation format of the control message based on the estimated emotional state.

20. A method performed by circuitry of a server coupled to a packet-switched network via a communication interface, the method comprising:
receiving, via the communication interface, a data packet from a terminal device coupled to the packet-switched network;
performing natural language processing on payload data extracted from the data packet to generate a feature vector representing a semantic interpretation including at least a relationship label, an urgency label, and a classification label;
constructing a prompt data structure encoding the feature vector and transmitting the prompt data structure to a generative neural network model via an inference interface;
receiving, from the generative neural network model, inference output data including an evaluation score and at least one query data structure;
transmitting a query message via the communication interface to at least one external storage device coupled to the packet-switched network, and receiving a comparison result indicating whether the payload data corresponds to a pattern that deviates from a baseline pattern stored in the at least one external storage device;
computing a composite score based on the evaluation score, the comparison result, and historical data retrieved from a database coupled to the packet-switched network;
when the composite score satisfies a predetermined threshold, transmitting, via the communication interface, a control message including a notification payload and the at least one query data structure to the terminal device, and setting a state flag that restricts execution of a pending operation at the terminal device;
receiving, via the communication interface, a response message from the terminal device, constructing an updated prompt data structure including data from the response message, and transmitting the updated prompt data structure to the generative neural network model to obtain updated inference output data; and
writing, to a log storage coupled to the packet-switched network, a record associating the prompt data structure, the inference output data, the comparison result, and the control message with a session identifier.
